(19) United States
(12) Patent Application Publication
(10) Pub. No.: US 2017/0311574 A1
(43) Pub. Date: Nov. 2, 2017

(54) ANIMAL MOVEMENT MAPPING AND MOVEMENT PREDICTION METHOD AND DEVICE

(71) Applicant: Michael W. Swan, Green Bay, WI (US)

(72) Inventor: Michael W. Swan, Green Bay, WI (US)

(21) Appl. No.: 15/651,750

(22) Filed: Jul. 17, 2017

Related U.S. Application Data
(63) Continuation-in-part of application No. 14/657,424, filed on Mar. 13, 2015, now Pat. No. 9,706,756.

(51) Int. Cl. A01K 29/00; G08G 1/09; G06K 9/78; G06K 9/62; G06K 9/00; H04N 7/18; A01M 31/00

(52) U.S. Cl. CPC A01K 29/005; H04N 7/181; G08G 1/09; G06K 9/78; A01M 31/002; G06K 9/00771; G06K 9/00362; G06K 9/00335; G06K 9/6212

(57) ABSTRACT

An animal movement prediction method including the steps of establishing, obtaining, processing, receiving and predicting. The establishing step establishes a wireless mesh network of a plurality of remote imaging sensors. Each sensor is established in the wireless mesh network by installing the sensor on an object to detect the animal in a detection zone; and activating the sensor. The obtaining step obtains an image by way of the first imaging sensor. The processing step process the image by removing image information that is not part of an animal in the image thereby creating an animal image and compiling animal detection information of the animal. The receiving step receives animal detection information from the sensors by way of the mesh network. The animal detection information includes a time of detection. The predicting step predicts the future movements of animals dependent upon the animal detection information.

### CROSS REFERENCE TO RELATED APPLICATIONS

This is a continuation-in-part of U.S. patent application Ser. No. 14/657,424, entitled “ANIMAL MOVEMENT MAPPING AND MOVEMENT PREDICTION METHOD AND DEVICE”, filed Mar. 13, 2015, which is incorporated herein by reference.

### BACKGROUND OF THE INVENTION

### 1. Field of the Invention

The present invention relates to an animal tracking system, and, more particularly, to a deer movement analysis system.

### 2. Description of the Related Art

Deer hunters need to know not only where the game travels but also its traveling habits in regard to time. While some game may be stalked, the hunter, particularly if using limited range weapons such as a bow and arrow, generally has to wait for the game to come to him.

An effective method of hunting deer is to take a somewhat hidden position, generally elevated in a tree, along a path known to be traveled by the deer. The deer hunter takes a position ten or twenty feet in the air, but even with the best equipment, it is not pleasant to resist the coldest weather for more than a few hours. Additionally the hunter must remain substantially still for fear of being seen by the deer. Often the sport can be unrewarding unless the hunter's timing is right.

It is important that hunters not only know where the deer pass, but also at what time of the day they pass a particular location. The timing of the hunter depended upon mere guesswork or clues located along the trail. Deer are creatures of habit and tend to follow the same trail at approximately the same time each day. If the deer started their day close to the tree stand, it might pass there early in the morning. Conversely, if the deer started very far from this tree stand, it might not arrive there until evening.

The difficulties described above with respect to hunting deer are typical problems encountered with other game as well. The signs at the location will readily tell the hunter what type of animal passed that point.

In addition, it is of great interest to naturalists to study the habits of animals. While devices have been developed for studying animals in captivity, there is a great need for devices to study the time related habits of animals in the wild. There is a particular need to provide devices which will not upset the natural habits of game, yet allow detailed and accurate study of their time related habits.

None of the prior art devices satisfies the needs of determining the movement habits of animals in the wild.

What is needed in the art is a system for determining the traveling habits of animals in the wild as well as deducing information about the animals from their images without interfering with their natural activities.

### SUMMARY OF THE INVENTION

The present invention provides a method and system for detecting the movement of animals and predicting their future movement dependent upon predicted environmental conditions.

The invention in one form is directed to an animal movement prediction method including the steps of establishing, obtaining, processing, receiving and predicting. The establishing step establishes a wireless mesh network of a plurality of remote imaging sensors. Each sensor is established in the wireless mesh network by installing the sensor on an object to detect the animal in a detection zone; and activating the sensor. The obtaining step obtains an image by way of the first imaging sensor. The processing step process the image by removing image information that is not part of an animal in the image thereby creating an animal image and compiling animal detection information of the animal. The receiving step receives animal detection information from the sensors by way of the mesh network. The animal detection information includes a time of detection. The predicting step predicts the future movements of animals dependent upon the animal detection information.

The invention in another form is directed to an animal movement prediction method including the steps of: receiving animal detection information from imaging sensors, each reception defining an animal detection event; associating a plurality of indicators with each animal detection event from an image taken by one of the imaging sensors thereby creating a snapshot of information; saving the snapshot of information; and predicting future movements of animals dependent upon the snapshots of information and predicted future environmental conditions.

An advantage of the present invention is that it considers future environmental conditions and how past similar conditions caused deer to move.

Another advantage is that the present invention uses techniques to reduce the data being communicated.

Yet another advantage is that the present invention enhances the probability of a successful hunt for the hunter using it.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematical illustration of an embodiment of a deer movement prediction system of the present invention;

FIG. 2 is another schematical illustration of another embodiment of the deer movement prediction system of the present invention;

FIG. 3 illustrates a sensor setup along a deer trail for use with the systems of FIGS. 1 and 2;

FIG. 4 illustrates the timing of deer movement at a particular sensor of the system of FIGS. 1-3;

FIG. 5 illustrates the probability of seeing a deer proximate to a particular sensor dependent upon the wind direction;

FIG. 6 illustrates a chart denoting a correlation of time and wind data at a sensor;

FIG. 7 illustrates an image and a processed image of a deer; and

FIG. 8 illustrates an image and a processed image of another deer.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

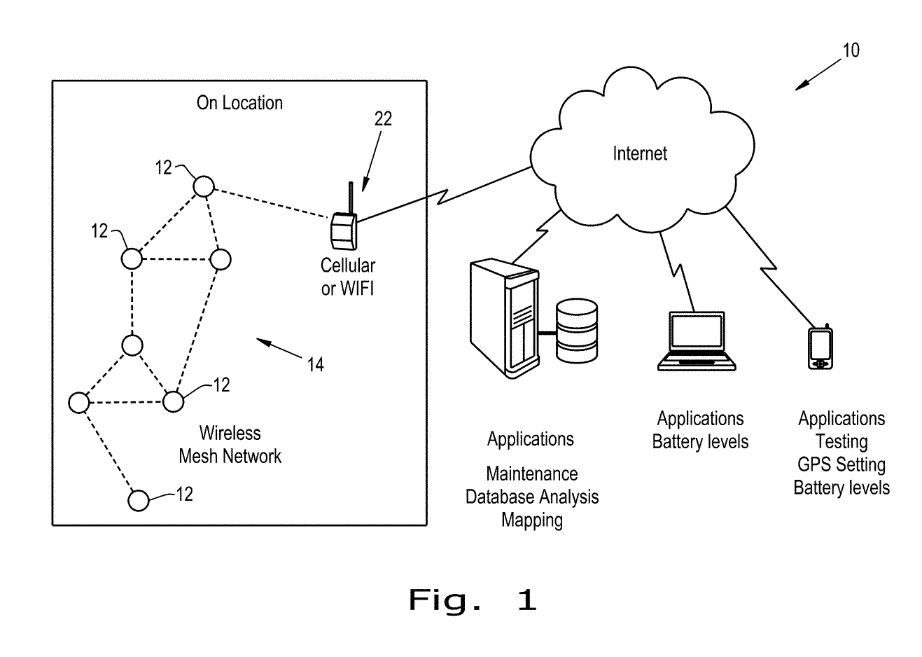

Referring now to the drawings, and more particularly to FIG. 1, there is shown an animal movement prediction system referred herein as the DeerMapper system 10 that automatically detects live deer movement events by way of multiple sensors in a wireless mesh network 14 that transmits information about these events to an online database for statistical analysis, mapping and prediction. Although deer is used herein as the example of the animal being studied, it is also contemplated that other animals can be studied using the inventive system described herein.

The sensors have one simple purpose, which is to capture every movement event within their detection range. This is done without lights or moving parts. The sensors are low cost, reliable and simple to set up with little to no ongoing maintenance. Each single-purposed sensor is small, silent, invisible to the deer and long lasting. DeerMapper's strength is in this simplicity multiplied over many sensors and thousands of events, expanded with automated Internet research into a sophisticated data structure from which extensive statistical analysis is done. The results are easy to understand and highly reliable for predicting future deer movements. No prior art system exists that enables extensive research into when and why deer move from one location to another.

Modern hunting practice is to sit along trails waiting for deer instead of participating in organized deer drives. This modern style of hunting requires that the hunter pattern deer habits to predict which trail gives the hunter the best probability of success with minimum time on the tree stand. This provides a particular challenge for hunters whose land is too far away to scout with sufficient frequency to be able to predict the optimal time and place to sit.

DeerMapper 10 provides the answers as to why deer move from one location to another. The base element, which defines and predicts these movements is a statistical snapshot of natural factors, calculated influences, action triggers and outside influences. Frequency distributions of these snapshots are then used to clearly illustrate the cause for deer movements. In addition, that illustration, when compared to the conditions of a future event, will validate the probability of movement at that future event's time and place.

For the user of the inventive system, the veracity of DeerMapper 10 is continually refined by increasing the number of sensors and the length of time they are active at the location. This ever increasing data becomes invaluable when shared among multiple neighboring landowners or used in aggregate by biologists and Departments of Natural Resources by continually providing a basis for new studies into the factors, influences and triggers that motivate deer to move from one location to another.

Terms Used in FIG. 1 and Elsewhere
On Location: On location represents the user's plot of land where users wish to capture and analyze deer movements.
Network: The sensors, placed on the best trails throughout the acreage, communicate with each other and to a gateway 22 to form a Wireless Sensor Network (WSN). This network is designed in a full mesh topology for better reliability, longer end-to-end range, lower data rates, lower power levels and extended battery life of one year. This mesh network 14 topology (hierarchy) incorporates an extra set of communication features such as authentication and encryption, in the upper layer application services, to further strengthen the association between sensors.
   As new sensors are added or sensors are moved to a new location, the network automatically reconfigures itself to establish the best routes by many-to-one aggregated routing. This full mesh network 14 can handle hundreds of sensors and dozens of hops.
   At any time by way of a PC, tablet or phone app, the user can read the RSSI (Received Signal Strength Indicator) and LQI (Link Quality Indicator) of each sensor and gateway 22 to show the current signal strength and quality of each node on the network.

Requirements:
The range of the sensor must be at least one half mile taking into account barriers of trees, leaves, buildings and hills.
The sensor range is rated at six miles (line of sight) with machine-to-machine (M2M) mesh capability to allow multiple hops to cover even longer distances. This longer distance, measured in miles, makes DeerMapper 10 unique by being able to cover a user's large acreage in remote areas.
The network topology is part of, but not limited to, the 802.15.4 ZigBee Alliance at 900 MHz and 250-750 mW of output power for extended range and reliability.
Sleep mode, small data size and lower data rates extend battery life.
Internet: Using a phone app, tablet or PC the user logs into a web application to set up and test the sensors and gateway 22. This Internet login will also provide access to the DeerMapper 10 maintenance, database analysis, mapping, prediction and gaming web applications (note the section below titled ‘Gaming’).
Sensor: The sensor (node) captures then transmits event data to the gateway 22. The DeerMapper 10 sensor technology includes, but is not limited to, passive infrared (PIR) for detection of deer movement. The information determined includes the time of detection, direction and speed of travel, distance from the sensor and size of the animal. The size criteria is used in the analysis to differentiate between deer and smaller animals such as raccoons, foxes, coyotes or turkeys.
   The sensors are equipped with a choice of changeable camouflage covers. These textured covers are designed to blend into tree trunks of oak, maple, pine, beech, ash, poplar or birch. These textured covers camouflage the sensors to look very much like a knot on a tree.
   The effectiveness of these covers can make it difficult to find the sensors. To overcome this issue the DeerMapper phone app comes with a sensor locate functionality. The app marks the location of the user, gateway 22 and each sensor registered to that user on a live map, making it easy for the user to walk directly to the sensor of their choice.
   The camouflaged cover is designed to fit all antenna types (regular, dipole or high-gain). The antenna choice is dependent on the optimal distance needed between sensors for the location. The high-gain antenna will reach ranges four to five times further between sensors but with additional cost.

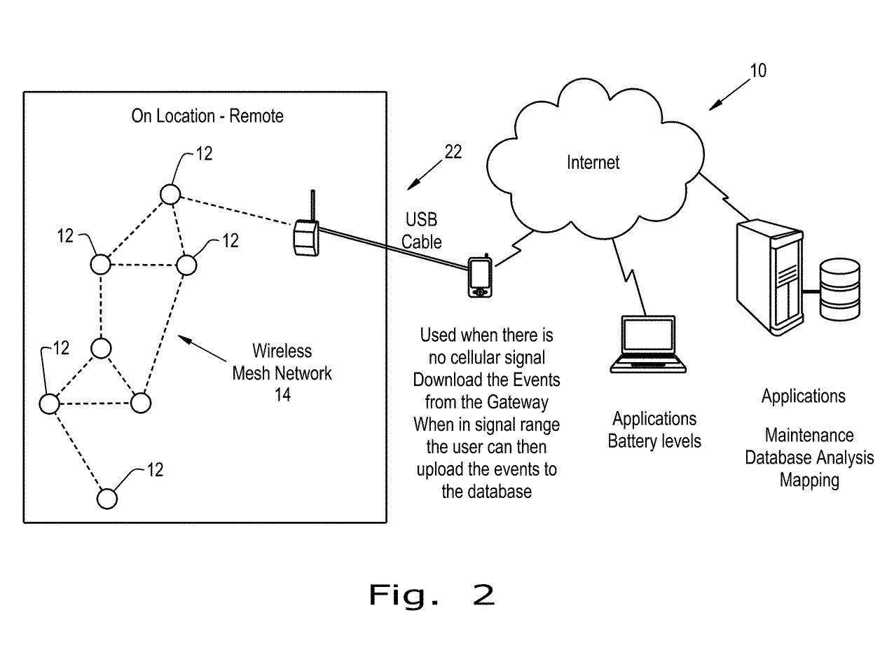

Requirements:
The sensor has extended battery life of one year, low cost, small size, no lights or buttons, and is testable and controllable by way of the phone app or computer.
The sensors maintain high level security and encryption to eliminate interference from neighboring networks.
DeerMapper 10 has a built in antenna for a range of one mile between sensors. To extend the range up to 28 miles there are two additional options, dipole or high-gain available.
Event Data: A movement event is triggered when a deer enters the detection zone 18 of a sensor 12. The event data transmitted will include the sensor ID, battery level, RSSI (Received Signal Strength Indicator), LQI (Link Quality Indicator), event date/time, pixels, animal size, distance from sensor 12 and direction of travel.
Gateway: The gateway 22 receives event data from sensors 12, then transmits, by way of cellular or WIFI, the event data to the internet database. When WIFI or cellular is available the gateway 22 has two-way interaction as a link between sensors 12 and the database.
   The exception is when the gateway 22 transmission frequency is set to ‘as needed’ for use in remote areas with no available cellular or WIFI signal. In this mode the events will be stored until the user goes to the gateway 22 to do a direct download. The user will connect a mobile phone, PC or tablet with a USB cable to the gateway 22 then download the events. In this scenario it is best to place the gateway 22 close to a road or in a building for easy access without disturbing the deer. See FIG. 2, to illustrate the present invention when the location does not have sufficient cellular signal or WIFI access.
   Simple text messaging of less than fifty bytes per event requires minimal cellular signal strength, signal quality and battery power. This feature of the present invention allows a greatly expanded range of DeerMapper 10 usage to remote areas where wireless trail cameras cannot function.
   The gateway 22 is part of a DeerMapper 10 pre-registered cellular subscription, so the user has no need to purchase a SIM card nor set up an account with a phone company. DeerMapper 10 uses agreements with multiple cellular services to provide the user the service that has the strongest signal in the selected location. The user needs only one gateway 22 to handle all of their sensors unlike wireless trail cameras, which require separate cellular plans for each camera.
   The gateway 22 can be placed indoors to protect it from outdoor elements and have access to power to eliminate reliance on batteries. If WIFI is available, the user can choose between cellular or WIFI connection service.

Requirements: The Gateway
is testable and controllable by the phone app or computer.
is low cost.
features extended battery life of one year with a sleep mode option.
is as small as possible with no lights or buttons.
offers optional power plug-in capability and WIFI
has four options for transmission frequency
   live
   hourly
   daily
   as needed
stores events until they are downloaded by one of three methods
   cellular transmission
   WIFI transmission
   direct cable download (used if the transmission frequency is set to ‘as needed’)
App: The user can access the sensors and the gateway 22 with the DeerMapper 10 phone app to
   do the registration, set-up and testing of the sensors and the gateway 22.
   change the transmission frequency for the sensors and the gateway 22 to live, hourly, daily or as needed.
   check the battery levels of the sensors and the gateway 22.
   check RSSI (Received Signal Strength Indicator) of the sensors and gateway 22.
   check LQI (Link Quality Indicator) of the sensors and gateway 22.

Requirements: The App Will
run on both the iPhone and Android.
take panoramic pictures at sensor sites for viewing with the 360 degree viewer.
do analysis, mapping, prediction and gaming.
download the events from the gateway 22 by way of cable and then, with cellular signal or WIFI, upload the events into the online database.
locate a registered sensor 12 or gateway 22 by way of a live map interface.
Database: The online database contains account, event, sensor data and gateway 22 data from which to do the analysis by login name. Supporting tables include natural factors, calculated influences, action triggers, and outside influences, rutting phases and moon phases.
   As each event data record is transferred into the database, DeerMapper 10 will add the GPS location from the sensor file and the matching weather information from the Internet.
   Partnering trail camera companies can set up their wireless cameras to do live transmission of their pictures directly into the DeerMapper online database. The image is treated as supplemental data as DeerMapper 10 cannot control its accuracy nor completeness. The image data is not be included in the statistical analysis.
Analysis: The online user is provided control of their gateway 22 and sensors from a mobile device 16, such as a mobile phone, tablet or PC. The user has access to deer movement analysis, prediction analysis and mapping of the events represented by their account in addition to information from online sources that augments and is analyzed with the sensor data.
Registration: A new user must first set up an account on the DeerMapper web site. Once an account is established, they will register their sensors 12 and gateway 22 under that account.
   This registration will ensure that . . .
      the sensor 12 setup, testing and data collection will only work with the sensors 12 and gateway 22 registered under that user account.
      if a sensor 12 or gateway 22 is stolen it cannot be set up without the user account login that matches the registration.
      the registered user has access to DeerMapper technical support, repairs and exchange services.
      the DeerMapper support service includes online access to the registered user's sensors 12, gateway 22 and database for maintenance only if the registered user allows access.
      the registration process with the government is complete for both the cellular and network PCS rules (Personal Communications Services).
Gaming: The purpose of DeerMapper gaming is to provide income, education and fun for gamers, location owners, hunting camps, sport shows and retailers. The DeerMapper game is not a simulation. The game is in real time, with live deer in their natural setting. There is no human presence required at the location so the deer are not disturbed, chased or shot at.
   Location owners can earn income from DeerMapper 10 by registering their location as one available for gaming. To qualify, the owner's location must have at least ten sensors with a minimum of three months of event history. The owner will set up morning or evening gamer hunts using a set of selected sensor sites. To protect the privacy of the owner and location, only the location's state is specified, without any GPS data.
   The DeerMapper gamer's experience is similar to the Fantasy Football gamer's experience in that they are both played real time, under live conditions, where the gamers do not know for sure what will happen, until it happens. They are both games. The better the understanding of the game (hunt), the players (deer) and game scenarios (conditions), the higher the odds of winning. Also like Fantasy Football, DeerMapper games are educational and provide a sense of anticipation.
   To play DeerMapper, gamers select a hunt, study its event history, choose the best sensor site and make their bid. The players with the best odds are those who understand why the deer move under the conditions presented in the hunt. Since the hunts are in real time and live, conditions are subject to change, so the bids are also changeable at specified times during the hunt.
   The player's score is determined by the number of individual deer, groups of deer, and quality of deer that move past their selected sensor 12. If an optional wireless deer camera is included in the game, it is the responsibility of the owner to close the hunt by entering the picture scores, which rate the size of the bucks at the end of the game. DeerMapper will automatically score the hunt, then pay out the winners and owners.
   The DeerMapper mobile phone app provides the owner with the ability to take panorama style pictures at each sensor site. From the DeerMapper web site, the owner will be able to edit those pictures by adding compass-direction readings, weather data, live statistics, trails and distance markings. The gamer can then monitor the game, real time, using the 360 degree picture viewer included on the game site. No identifying site information will be visible to them.
   What makes DeerMapper gaming so interesting to play is that the deer are real and they alone decide when they get up and move. Because they are creatures of habit, their behavior can be patterned. However, the factors that determine those repetitive patterns are the complex social effects of their herd, food and water availability, weather and seasonal changes, rut phases and intruders. Deer remain continually alert and have incredible senses for detecting danger, sounds, smells and movements. They communicate with each other through sounds, scent trails and body positioning, among other things. Many factors can interrupt their normal patterns. Therefore, what may seem easy to the lucky hunter is in reality very complex. It is DeerMapper's inclusion of comprehensive behavioral influence that makes the game challenging, educational and exciting.
Certification: DeerMapper certification enhances the value of hunting land by making available the analysis of deer movement activity on the land. This gives the landowner, deer camp and realtor an added sales benefit when leasing or selling the land for whitetail hunting. The requirements for DeerMapper certification is at two levels:
   Silver Seal: The DeerMapper system is installed and available.
   Gold Seal: The DeerMapper service has been in operation at least one full season.
   The owner will receive a personalized registered seal to print and be available to place on their website, sales literature or lease agreement.

### Leased Land Services:

The DeerMapper website has a service for landowners, deer camps and realtors to list their hunting land for sale or lease. Landowners and realtors who have a DeerMapper certification will list their land with the personalized seal as part of their listing and be listed separately as they provide an new value for the prospects to actually login to the land's DeerMapper data and do analysis on the deer herd before they buy. Also, the DeerMapper system helps the hunter locate deer on their new hunting land.

Sensor Testing and Setup:

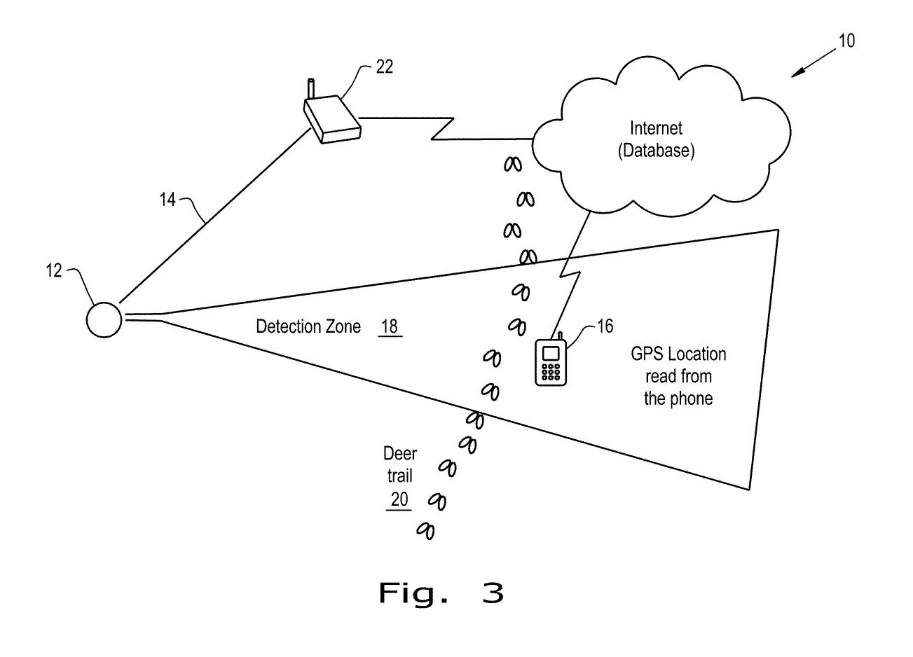

The gateway 22 must be in place before the sensors 12 can be set up. While placing each sensor 12, the user must verify, by way of the phone app, the RSSI (Received Signal Strength Indicator) and LQI (Link Quality Indicator) to gateway 22. If the sensor-to-gateway distance is too great or there are barriers affecting the signal and it is weak or depleted, the integrity of the analysis is at risk. This is a continual read, allowing the user to walk to maximum distances and know exactly where the signal breaks down, thus enabling them to be able place the sensors 12 with confidence and in their ability to maintain a reliable signal (See FIG. 3: Sensor Setup).
1. The user attaches sensor 12 to a tree, aiming the sensor 12 at a deer trail 20′-30′ away.
2. Using the DeerMapper 10 app on their mobile phone 16, the user activates the sensor test.
3. Carrying phone 16, the user walks along deer trail 20 into detection zone 18.
4. When sensor 12 detects the user's presence in the zone, sensor 12 transmits the event data to gateway 22.
5. Gateway 22 then transmits the event data to the app and the database.
6. When the app receives notification of the event, it displays: “Sensor Event Data Received”.
7. The RSSI signal strength and LQI signal quality of sensor 12 is also displayed.
8. Upon notification, the app will update the sensor's GPS location (using the GPS location of phone 16) and the sensor's distance to the trail 20.

This extremely accurate GPS data, determined not by using sensor 12, but the GPS location of phone 16 on the deer trail 20, is an important feature of the present invention, not found in any other system.

Sensor 12 will determine the distance to the user carrying cell phone 16 and register that distance as the sensor's distance to the trail. As each event occurs, DeerMapper 10 will know whether or not the deer is on the trail 20 by comparing the distances. This is an important factor in the analysis of determining the maturity and sex of the deer because bucks tend to take up stances that are off the trails 20, whereas does and immature deer tend to remain on the trail 20.

The exception is when the system is set up in a remote area where there is no cellular or WIFI signal. The setup process remains the same except the user must carry gateway 22 and phone 16, with gateway 22 connected to phone 16 by way of a cable. After the sensors 12 are all in place then gateway 22 is placed to complete the setup.

Functional Overview Summary:

Deer move naturally between bedding, watering, feeding and breeding areas. Deer sometimes change their home range as a result of seasonal changes, agricultural activity, wandering or having been chased.

The factors that cause deer to move from one location to another is the main question DeerMapper 10 is designed to answer. The conclusion will be drawn from 120 factors, influences, and triggers that can cause deer to move, determine when they move, show the direction the deer came from and determine where they are heading. Ultimately, when presented a forecast of conditions, DeerMapper 10 will predict deer movements based on trends established by the location's historical data.

DeerMapper 10 will detect these moving deer at selected locations with sensors. These deer movement events are then transmitted to an online database where the DeerMapper 10 statistical analysis, mapping, prediction and gaming occurs.

The sensors, gateway 22, wireless sensor network, mesh configuration, phone app and database all must work together as a single system to enable execution of the DeerMapper 10 analysis. The data must be precise, extensive and generated by the DeerMapper 10 equipment, because human data generation is inadequate and imprecise. The more sensors, events, factors, influences and triggers available in the frequency distributions, the more valuable and accurate will be the statistical analysis, mapping, prediction and gaming. This can only be accomplished when each component is integrated together into the underlying organizational schema.

Trail camera pictures and manual data entry can be used as ancillary information but are inadequate and too irregular and independent to form a basis for DeerMapper-quality data gathering and analysis.

Wireless trail camera companies will be provided with the opportunity to transmit their information directly to the database as supplemental data. However, the DeerMapper analysis does not require wireless trail cameras or their associated image handling systems, analyses or databases. DeerMapper analysis will recommend the best locations to place trail cameras to add the value of pictures to deer movement events. By working with DeerMapper 10, the cameras can provide added insight into the patterns of an individual animal or to evaluate the make-up, movements and quality of the herd.

Wireless trail cameras lack data. While the trail camera may provide GPS coordinates, they represent the location of the camera, not the deer. The battery level, pixels, animal size, distance from camera, direction of travel and speed of travel are not included in a trail camera image. Since the cost is generally at least 10 times that of a sensor 12, many hunters and landowners find that it is not practical to place them in multiple locations. The missing data can be added manually but at a penalty of time consumption plus the subjectivity and limitations of such information reduces the effectiveness of attempting such a system and any resulting analysis.

DeerMapper 10 is designed with extended battery life and expandable transmission range to increase coverage of the natural deer movement location without human intervention. It is also designed to capture large amounts of data for each event to provide extensive statistical analysis that seeks to determine patterns within those natural movements. Using these patterns, DeerMapper 10 can apply propositional logic to the structured framework of the combined classifications, which are natural factors, calculated influences, action triggers and outside influences to predict a future movement at a specified time and place.

DeerMapper 10 provides, by way of PC, tablet or mobile phone 16, the RSSI (Received Signal Strength Indicator) and LQI (Link Quality Indicator) to enable the layout of a full mesh network 14 with maximum signal and range. As the sensors 12 are being placed, the user watches the RSSI and LQI while selecting locations that assure a strong signal to gateway 22 and across multi-hop sensors 12.

Only DeerMapper 10 can accomplish the functions defined in the above summary. Only DeerMapper 10 has uniquely created, named and defined the terms in its structured framework that makes this possible. Each classification has a set of indicators that form a one-of-a-kind relational data model structure.

Structural Framework of the Combined Classifications:

1. Classifications: Sensor readings, natural factors, calculated influences, action triggers and outside influences. There are 5 classifications of indicator values.
1.1. Indicators: An indicator is a measuring device that points to its value. It defines and quantifies the value and the rate of change of the environmental conditions at each event. There are 120 indicators.
   1.1.1. Indicator Values: The value and rate of change the indicator points to at each event.
      An example is the wind indicator pointing to the value of 15 mph changing at negative 8 mph per hour. This shows that the wind is dropping and in one hour will be approximately 7 mph.
         1.1.1.1. Rate of change: The rate of change of the indicator value at the time of the event
         1.1.1.2. Current Value: Current value at the time of the event

Snapshot: Each movement event is represented by a Snapshot that is a matrix or set made up of:
4 Columns: Classification, Indicator name, Rate of Change, and Current Value
120 Rows: Each Indicator of the event has the 4 column values defined above

Each GPS location has
a growing frequency distribution of these classifications and indicators represented by their mean (expected value), spread (standard deviation), slope (rate of change toward or away from the mean) and dispersion.
a growing set of movement events, called snapshots, that illustrate the event by capturing each indicator's value and rate of change at the moment of the event.
a changing list of the most influential indicators measured when their values are near the mean. The value near the mean presents the highest probability that a movement will happen. Generally, between five to ten of the most influential indicators is sufficient to accurately predict a movement time at the specific location.

Classifications: There are five classifications, defined below, represented as sensor readings, natural factors, calculated influences, action triggers and outside influences. Classifications are groups or categories of indicators with matching qualities. The classifications form the top level of a structured framework used to illustrate scenarios of deer movement. Each of the five classifications contain the indicators that collectively represent their qualities. The indicators values are numeric, providing a quantitative basis for effective statistical analysis.
1. Sensor Readings: These readings are the indicator values determined by sensor 12 when a deer enters its detection area. Each event triggered by sensor 12 is initially defined by these readings that form the basis for the full development of the event.
2. Natural Factors: These factors represent the indicator values existing in nature, not made or caused by people, as one of the things that cause a deer to move. These indicator values are obtained automatically by DeerMapper 10 through web search engine lookups and calculations that match the exact time and location of the event.
3. Calculated Influences: These influences are the calculated indicator values combining sensor readings, natural factors, outside influences and action triggers. These calculations are unique to DeerMapper 10 and not available from any web search engine lookups. These influences indirectly or intangibly have the power to cause deer to move. They are best expressed collectively. An example is the wind influence which includes the wind speed, wind direction, wind shift, and veering wind. Deer will move during a wind change but the speed of travel, trails they use, and the time they move will be determined by the combinations of factors calculated together as a calculated influence.
4. Action Triggers: These triggers are direct causes of movement, not collectively dependent on other indicators. When the trigger value changes and enters an action range on the distribution curve, it will be the cause of a movement. These action ranges are defined via the tendency of quantitative data to cluster around some central value where the strongest probability for change occurs. The cluster or central value is called the mean of the indicator. Examples include wind change, barometric pressure change or dwindling daylight.
5. Outside Influences: These outside influences cannot be determined by sensor 12, web search engine lookups or calculation. These are influences that affect movements that must be entered by the user based on their observation near each sensor 12. Examples include cover, agricultural activity, logging, feeding stations or building projects.

The number of calculated influences will grow as more combinations of readings, factors, influences and triggers are discovered through statistical analysis.

Snapshots—The snapshot is a scenario-based matrix of 204 indicator values that define an event represented as numeric values. When a deer enters detection zone 18 sensor 12 creates an event of sensor readings, the beginnings of a snapshot. DeerMapper 10 will then develop the remaining indicator values, for each classification, to complete the snapshot of the event at a single GPS location (on deer trail 20) and point of time. This development is done through web search engine lookups and proprietary calculations.

The snapshot matrix is made in four columns: classification, indicator name, rate of change and current value. The rows are these four values for each of the 120 indicators. So, a snapshot is a matrix with 480 cells to illustrate each event. Note that the “Rate of Change” value is relevant 28 times for analysis which leaves 388 separate distribution curves to include in the analysis.

The DeerMapper snapshot is the foundation of its statistical analysis, mapping, prediction and gaming. Scenario evaluation is used for assessment of future situations by searching for matching snapshots. Retrospective and prospective studies of the snapshots seek patterns of indicators that cause movement, which will have long-term value for biologists, Departments of Natural Resources and other organizations with responsibility for or interest in deer habits, in addition to the hunters and landowners.

Indicators—The indicator defines and quantifies a condition at its current state of the moment when an event occurs. An indicator is a measuring device that points to its current value and current rate of change.

Wind speed, wind direction and wind change time are just three examples of the 120 unique indicators in a snapshot of an event. If the wind is from the north, the deer will naturally move in the evening to feed in the south field because the wind comes out of the woods onto that field. In this scenario the deer feel safe as they travel east and west along the edge of the field, smelling what is out of sight in the woods.

Wind is one of the most influential triggers for activating deer movement. It is influential but not conclusive because other factors, influences or triggers can skew the probability of the movement. The highest probability is discovered by analyzing many events in the sample data which share common factor, influence and trigger values.

Each indicator also has a rate of change value at the time of the event. The indicator maintenance table defines how this calculation is done by quantifying the size of the change range. The wind change range will be set between one and two hours. If the range is set to one then a rate of change of “−7” will mean that one hour before the event the wind would have dropped 7 mph. These rates for each indicator will be tracking changes, not just current values that are affecting the movements.

When an event occurs, the Snapshot is built and these values are added to the frequency distribution tables of each indicator for each GPS location. DeerMapper 10 will keep their mean (expected value), spread (standard deviation), slope (rate of change toward or away from the mean) and dispersion current on these frequency distribution tables. As these tables grow, so will the accuracy of predictions of deer movements.

The average hunter could be overwhelmed by the volume of data available. To simplify the use of the present invention, DeerMapper 10 has maximized technology so the data is gathered and analysis is done without effort by the user. The user can look at a single map illustration to decide where to hunt or can study the several adjustable charts, graphs and maps to further understand the predicted movements for the hunt.

Frequency Distribution—When deer move, they will trigger events at sensor locations. As these events are repeated, the number of indicator values in the database grow, as do the viability of the frequency distributions in defining each indicator's mean, mode, medium and slope. The modality of these curves may be unimodal, bimodal or multimodal or skewed but the ranges of values will clearly represent what caused the movements.

For example: Change in wind from south to northwest or from north to southwest are both common causes of deer movement from one bedding area to another, even in the middle of the day. As the data of events increases the distribution curve for the “change in wind” indicator will spike near both of these values for the indicator. This forms two means and active ranges to the distribution curve. Either of the means of the bimodal curve can be the cause of a movement. Most of the indicators will form a normal curve with one mean=mode=medium and the skewness=(mean−medium)/standard deviation=0.

As these frequency distributions mature, their means plus range of value (distribution) will be clear and will provide a high probability of a correct forecast of movement. To provide an even greater predictability, DeerMapper 10 combines multiple indicators together to form a single frequency distribution.

Each indicator is detailed by its mean (expected value), spread (standard deviation) and slope (rate of change toward or away from the mean). The action range is made up of the indicator's mean, standard deviation and slope to express the probability that the indicator measurement represents the cause of the deer movement.

Indicator Detail by Classification

The class intervals of the frequency distribution for each indicator will be determined by its historical data. The class intervals are changeable in each indicator distribution report to best represent the data as it comes in.

Each indicator has two values . . .
Rate of change: The rate of change of the value in a predetermined set of time either hours or days.
   Each indicator has its own maintenance file which holds the ‘range of time’ on either side of the event time to measure the rate of change.
   Each indicator is unique in this range. The calculation results in a positive, zero or negative number to represent the change up or down the slope. When a lapse rate is available, it will be used.
Current Value: The current value
   Each indicator can be turned on or off by the user or by DeerMapper 10.
   When an indicator's value remains constant throughout the analysis period (change value is at zero), DeerMapper 10 will extract it from the analysis or it can skew the results.

Sensor Readings:

Sensor File
GPS location GPS location of the deer trail 20 in the detection zone 18
Trail distance Distance from the sensor 12 to the trail 20 (entered in the phone app at sensor 12 set up)
Direction The direction to trail 20 from the sensor 12 in Degrees (entered in the phone app at sensor set up)

Note: 0 Rate of Change means that there is no application relevant to the analysis.

There are 120 unique indicators in DeerMapper 10 with 28 Rate of Change calculations.

| Classification | Indicator | Current Value | Rate of Change |
|---|---|---|---|
| Sensor Reading | Sensor ID | The sensor ID representing the sensor | 0 |
| | | and the account it is registered to | |
| Sensor Reading | Event date/time | The date/time the deer entered the | 0 |
| | | detection zone to the nearest minute | |
| Sensor Reading | Battery level | Percent of battery available | 0 |
| Sensor Reading | RSSI | Signal Strength to the gateway 22: | 0 |
| | | Received Signal Strength Indicator | |
| Sensor Reading | LQI | Signal Quality to the gateway: Link | 0 |
| | | Quality Indicator | |
| Sensor Reading | Pixels | Number of heat pixels when the deer | 0 |
| | | is in the middle of the detection zone | |
| Sensor Reading | Animal Size | Larger than a deer, deer size, smaller | 0 |
| | | than a deer | |
| Sensor Reading | Distance from Sensor | To the nearest foot | 0 |
| Sensor Reading | Direction of Travel | To the Left or right | 0 |
| Sensor Reading | Speed of travel | to the nearest miles per hour | 0 |
| Natural factors | Temperature | Current Temperature in degrees | Maximum temperature |
| | | Fahrenheit | change in the last 2 |
| | | | hours |
| Natural factors | Max Temperature | Maximum temperature in the past 24 | 0 |
| | | hours in degrees Fahrenheit | |
| Natural factors | Min Temperature | Minimum temperature in the past 24 | 0 |
| | | hours in degrees Fahrenheit | |
| Natural factors | Heating Degree Days | Total temperature in a day above the | 0 |
| | | mean in degrees Fahrenheit | |
| Natural factors | Cooling Degree Days | Total temperature in a day below the | 0 |
| | | mean in degrees Fahrenheit | |
| Natural factors | Visibility | How far away objects are visible to a | Maximum change in |
| | | person - identified with the unaided | statute miles in the last |
| | | eye in statute miles to nearest tenth | 2 hours |
| Natural factors | Tides | The water level in feet above or below | Maximum change in |
| | | Mean Low Water | feet in the last 2 hours |
| Natural factors | Dew Point | A measure of atmospheric moisture - | Maximum change in |
| | | temperature for air to reach saturation | degrees in the last 2 |
| | | | hours |
| Natural factors | Humidity | Humidity level in percent | Maximum change in |
| | | | percent in the last 2 |
| | | | hours |
| Natural factors | Sunrise | Time of sunrise by minute | 0 |
| Natural factors | Sunset | Time of sunset by minute | 0 |
| Natural factors | Wind direction | Compass degree | Maximum change in |
| | | | percent in the last 2 |
| | | | hours |
| Natural factors | Wind speed | Miles per hour | Maximum change in |
| | | | Miles per hour in the |
| | | | last 2 hours |
| Natural factors | Wind Shift | Time: Change in wind direction of 45 | When did the change |
| | | degrees or more in less than 15 | last occur in hours. If |
| | | minutes | the change is more |
| | | | than four hours the |
| | | | value is zero |
| Natural factors | Veering Winds | A clockwise direction switch in wind. | When did the change |
| | | This is the time it occurred | last occur in hours. If |
| | | | the change is more |
| | | | than four hours the |
| | | | value is zero. |
| Natural factors | Backing | A counter clockwise switch in wind. | When did the change |
| | | This is the time it occurred | last occur in hours. If |
| | | | the change is more |
| | | | than four hours the |
| | | | value is zero. |
| Natural factors | Vorticity | Is a clockwise or counterclockwise | When did the change |
| | | spin in the troposphere 0 = no 1 = yes | last occur in hours. If |
| | | | the change is more |
| | | | than four hours the |
| | | | value is zero. |
| Natural factors | Snow Advisory | 0 = no 1 = yes | 0 = no and 1 = yes for a |
| | | | snow advisory in the |
| | | | last 2 hours |
| Natural factors | Snow | How fast it is snowing - 0 = none | Maximum change in |
| | | 1 = sleet, 2 = flurries, 3 = moderate, | the last 2 hours |
| | | 4 = heavy | |
| Natural factors | Snow total | Snow total in the last 24 hours | 0 |
| Natural factors | Snow Depth | Depth of snow on the ground in | Maximum change in |
| | | inches | the Depth of snow in |
| | | | the last 2 hours |
| Natural factors | Rain | How fast it is raining - 0 = none | Maximum change in |
| | | 1 = mist, 2 = sprinkle, 3 = moderate, | the last 2 hours |
| | | 4 = heavy | |
| Natural factors | Rain total | Total rain in the last 24 hours | 0 |
| Natural factors | Rain last week | Total rain in the last week | 0 |
| Natural factors | A Index | Solar-terrestrial index of geomagnetic | 0 |
| | | activity (flares, geomagnetic storms) | |
| | | SFUs (Solar Flux Units) solar flux | |
| | | 2.8 GHz | |
| Natural factors | Artic Oscillation | Atmospheric pressure at polar/middle | 0 |
| | | latitudes fluctuates phases saturation | |
| Natural factors | Cloud cover | Percent of the sky covered with | Maximum change in |
| | | clouds | percent in the last 2 |
| | | | hours |
| Natural factors | Sun illumination | Lux | Maximum change in |
| | | | lux in the last 2 hours |
| Natural factors | Ultraviolet Index | Ozone levels to UV incidence on the | Maximum change in |
| | | ground | Ultraviolet Index in |
| | | | the last 2 hours |
| Natural factors | Sun altitude | Angle from the horizon | 0 |
| Natural factors | Sun azimuth | Angle along the horizon | 0 |
| Natural factors | Astronomical Dawn | Time when the morning sun 18 | 0 |
| | | degrees below the horizon | |
| Natural factors | Astronomical Dusk | Time when the morning sun 18 | 0 |
| | | degrees below the horizon | |
| Natural factors | Declination | The latitude where the sun is directly | Maximum change in |
| | | overhead - show solstice and equinox | latitude declination |
| | | | from the day before |
| Natural factors | Insolation | The total amount of solar radiation | Maximum change in |
| | | energy received by surface area in the | the hourly irradiation |
| | | past hour | in the past two hours |
| Natural factors | Barometric pressure | Barometer in inches (hundredths) | Maximum change in |
| | | | Barometric pressure in |
| | | | the last 2 hours |
| Natural factors | Pressure Change | The net difference between the | 0 |
| | | barometric pressure at three hour | |
| | | intervals | |
| Natural factors | Moon illumination | Lux | Maximum change in |
| | | | lux in the last 2 hours |
| Natural factors | Moon rise | 24 hour time of the moon rise to the | 0 |
| | | closest minute | |
| Natural factors | Moon set | hour time of the moon set to the | 0 |
| | | closest minute | |
| Natural factors | Moon minor begin time | 24 hour time to the closest minute | 0 |
| Natural factors | Moon minor end time | 24 hour time to the closest minute | 0 |
| Natural factors | Moon major begin time | 24 hour time to the closest minute | 0 |
| Natural factors | Moon major end time | 24 hour time to the closest minute | 0 |
| Natural factors | Lunar phase | Moon Phase 1 = New Moon, | 0 |
| | | 2 = Waxing Crescent, 3 = First Quarter, | |
| | | 4 = Waxing Gibbous, 5 = Full Moon, | |
| | | 6 = Waning Gibbous, 7 = Last Quarter, | |
| | | 8 = Waning Crescent | |
| Natural factors | Lunar - current age | how far along the moon is in a full | 0 |
| | | cycle in days | |
| Natural factors | Lunar - percent full | 0% to 100% full | 0 |
| Natural factors | Moon altitude | Angle from the horizon | 0 |
| Natural factors | Moon azimuth | Angle along the horizon | 0 |
| Natural factors | Length of day | Sunset minus sunrise in minutes | 0 |
| Natural factors | Alberta Clipper | Fast moving low pressure - this is a | Minutes since the |
| | | start time for that front if the same day | Alberta Clipper started |
| Natural factors | SWEAT | Severe Weather ThrEAT index, a | 0 |
| | | stability index developed by the Air | |
| | | Force. 150-300 Slight severe, 300- | |
| | | 400 Severe possible, 400+ Tornadic | |
| | | possible | |
| Natural factors | Lifted Index | Measure of atmospheric instability - | 0 |
| | | ground temperature compared to 18K | |
| | | feet | |
| Natural factors | Lapse Rate | The rate of change of an atmospheric | Maximum change in |
| | | variable, in this case temperature. | lapse rate in the last 2 |
| | | | hours |
| Natural factors | K-Index | A measure of the thunderstorm | Maximum change in |
| | | potential based on vertical | K-index in the last 2 |
| | | temperature lapse | hours |
| Natural factors | Cold Front | The time the cold front entered the | Minutes since the cold |
| | | area if more than 2 days mark it as | front entered the area |
| | | zero) | |
| Natural factors | Warm front | The time the warm front entered the | Minutes since the |
| | | area (if more than 2 days mark it as | warm front entered the |
| | | zero) | area |
| Natural factors | Convergence | The time the convergence occurs (if | Minutes since the |
| | | more than 2 days mark it as zero) | convergence occurred |
| Calculated influences | Sound factor Wind | Calculation combining wind speed | 0 |
| | | 1 = low, 2 = medium, 3 = high | |
| Calculated influences | Sound factor Crunch | Calculation combining rain, snow, | 0 |
| | | snow depth, date and temperature | |
| | | 1 = low, 2 = medium, 3 = high | |
| Calculated influences | Sound factor | Combined wind and crunch 2 (low), | 0 |
| | | 3, 4, 5 and 6 (high) | |
| Calculated influences | Scent factor | Combined wind, humidity, | 0 |
| | | temperature and precipitation | |
| | | 1 = low, 2 = medium, 3 = high | |
| Calculated influences | Scent factor Thermals | Combined wind, humidity, | 0 |
| | | temperature, precipitation and time of | |
| | | day 1 = low, 2 = medium, 3 = high | |
| Calculated influences | Time factors Morning | Calculation at time ranges | 0 |
| Calculated influences | Time factors Mid-day | Calculation at time ranges | 0 |
| Calculated influences | Time factors Evening | Calculation at time ranges | 0 |
| Calculated influences | Time factors Dark | Calculation at time ranges | 0 |
| Calculated influences | Wind Factor North | Calculation at four wind speed ranges | 0 |
| | (Azimuth 315°-0°-45°) | | |
| Calculated influences | Wind Factor East | Calculation at four wind speed ranges | 0 |
| | (Azimuth 46°-135°) | | |
| Calculated influences | Wind Factor South | Calculation at four wind speed ranges | 0 |
| | (Azimuth 136°-225°) | | |
| Calculated influences | Wind Factor West | Calculation at four wind speed ranges | 0 |
| | (Azimuth 226°-315°) | | |
| Calculated influences | Wind Factor Shift | Calculation at four wind shift ranges | 0 |
| Calculated influences | Wind Factor | Calculation at four wind speed ranges | 0 |
| Calculated influences | Speed factor | Calculation combining speed and | 0 |
| | | various sound, scent and outside | |
| | | influences | |
| Calculated influences | Location factors | Calculation combining percent chance | 0 |
| | | of movement at time ranges and place | |
| Calculated influences | Food factor | Calculation combining wind and | 0 |
| | | outside influences | |
| Calculated influences | Intrusion factor | Calculation combining wind, hunting | 0 |
| | | pressure, logging and outside | |
| | | influences | |
| Calculated influences | Cover factor | Calculation combining cover, habitat, | 0 |
| | | logging, construction | |
| Calculated influences | Photoperiod | Calculation combining time from | 0 |
| | | sunrise to sunset, illumination, cloud | |
| | | cover | |
| Calculated influences | On the trail | Calculation combining distance to | 0 |
| | | trail minus distance to the deer | |
| Calculated influences | Time after sunrise | Calculation combining event time | 0 |
| | | minus sunrise | |
| Calculated influences | Time before sunset | Calculation combining sunset minus | 0 |
| | | event time | |
| Calculated influences | Time before wind switch | Calculation combining wind shift time | 0 |
| | | minus event time | |
| Calculated influences | Time after wind switch | Calculation combining wind event | 0 |
| | | time minus shift time | |
| Calculated influences | Rutting phase | Lookup the rutting phase at the event | 0 |
| | | build 0 = no rut, 1 = pre-rut, 2 = seeking | |
| | | and chasing, 3 = peak-rut, 4 = post-rut | |
| Calculated influences | Moon rating | Lookup the moon phases, major, | 0 |
| | | minor to calculate how much of an | |
| | | influence | |
| Action triggers | Sound Range | Calculations using Sound Factor | 0 |
| | | Wind and Sound Factor Noise | |
| | | 1 = Short Distance, 2-Medium distance | |
| | | and 3 = Long distance | |
| Action triggers | Barometric change drop | Largest drop in hour 1, 2, 3 or4 | 0 |
| Action triggers | Barometric change rise | Largest rise in hour 1, 2, 3 or4 | 0 |
| Action triggers | Precipitation change drop | Largest drop in hour 1, 2, 3 or4 | 0 |
| Action triggers | Precipitation change rise | Largest rise in hour 1, 2, 3 or4 | 0 |
| Action triggers | Scent factor drop | Last drop of the Calculated Influence | 0 |
| | | Scent factor in hour 1, 2, 3 or 4 | |
| Action triggers | Scent factor rise | Last rise of the Calculated Influence | 0 |
| | | Scent factor in hour 1, 2, 3 or 4 | |
| Action triggers | Temperature change drop | Largest drop in hour 1, 2, 3 or4 | 0 |
| Action triggers | Temperature change rise | Largest rise in hour 1, 2, 3 or4 | 0 |
| Action triggers | Wind change veering | Last change in hour 1, 2, 3 or 4 | 0 |
| Action triggers | Wind change backing | Last change in hour 1, 2, 3 or 4 | 0 |
| Action triggers | Wind change shift | Last change in hour 1, 2, 3 or 4 | 0 |
| Action triggers | Wind change | 0 = no change, 1, 2 or 3 of the veering, | 0 |
| | | backing or shift occurred. | |
| Action triggers | Snow change | When did it originate: 0, 1, 2 or 3 | 0 |
| | | hours ago there was moderate to | |
| | | heavy snow. | |
| Action triggers | Rain change | When did it originate: 0, 1, 2 or 3 | 0 |
| | | hours ago there was moderate to | |
| | | heavy rain. | |
| Outside Influences | Agricultural activity | 0 = no influence, 1 = Plowed, 2 = just | 0 |
| | | planted, 3 = new growth, 4 = mature, | |
| | | 5 = cut | |
| Outside Influences | Predators | Predators in the areas like coyotes, | 0 |
| | | wolves or bears, 0 = no, 1 = yes | |
| Outside Influences | Building projects | 0 = no, 1 = yes | 0 |
| Outside Influences | Logging | 0 = no, 1 = yes | 0 |
| Outside Influences | Feeding stations | 0 = no, 1 = yes | 0 |
| Outside Influences | Hunting pressure | 0 = no, 1 = hunting season | 0 |
| Outside Influences | Competition | 0 = no, 1 = low, 2 = medium, 3 = high | 0 |
| Outside Influences | Distance to water | In yards | 0 |
| Outside Influences | Distance to field | In yards | 0 |

Calculations:

Calculated Influences are based mainly on the indicator value changes trends.

Sound factors—How a deer responds to these sound factors is what DeerMapper 10 seeks by adding these calculated factors to the analysis. Sound factor is effected by the wind and the dryness of the leaves. Deer change their behavior in calm wind or strong wind. The dryness of the fallen leaves will also effect the sounds in the woods. Loud, crunchy leaves means the sounds of moving animals carries long distances. New snow quiets the woods and deer move differently during this quiet time.

Sound Factor Wind
1=low wind (calm to 10 mph)
2=medium wind (10 mph to 20 mph)
3=strong wind (>20 mph)

Sound Factor Noise
1=low noise (Rain Total>1″ or Rain Last Week>1″ or Snow total>3″ or snow depth>6″) and (temperature>250)
2=medium noise is not a 1 or a 3 in the calculation.
3=high noise (date is between October 1 and November 30th) and (snow depth=0) and (rain last week<0.5 inch)

Sound Factor
Combined wind and noise factors: 2 (low), 3, 4, 5, and 6 (High)

Note that DeerMapper 10 is using qualitative data and converting it to quantitative data so that it works well in the statistical analysis. The objective is to make it as free from interpretation as possible so that the analysis is based on empirical data not intuition.

The results of large data samples provides new insights into how wind and crunch affect how the deer move. If they move later, earlier or in a different location dependent on the sound factor is to be determined by the data.

Scent Factor

Calculation combines humidity, rain, snow, wind speed, time of day. A deer's ability to smell is 100 times greater than humans. The scent factor is a major factor in the analysis affecting when, where and how fast deer move from one location to another.

If all factors are ideal, a deer can smell a human up to ½ mile away, yet if these factors are not, a deer can only smell 10 to 20 yards.

Factors Considered in this Calculation that Enhance a Deer's Sense of Smell
Humid air, greater than 50%, enhances a deer's sense of smell
The less wind the wider the scent cone
Ideal wind to carry scent long distances is 5 MPH
Strong wind creates a narrow scent cone but travels further
Thermals move up hill in the morning
Thermals move down hill in the evening

Factors Considered in this Calculation that Reduce the Sense of Smell
Low humidity reduces their sense of smell
Rain or snow reduce the deer's ability to smell as the scent is pushed to the ground
Rain and snow dilute the scent
Fog also reduces their ability to pick up a scent
Low humidity, between 10-20%, works against deer
High temperature, greater than 70° F., pushes the scent up thus reducing the scent
Low temperature, less than 20° F., pushes the scent to the ground thus reducing the scent

Scent Factor

1=Low Enhancement if Total1=3 or 4
(Temperature<20° or >69°) add 1 low or high temperature
(Humidity<30%) add 1 low humidity
(Wind Speed>19 MPH or wind=calm) add 1 high wind or no wind
(Raining or Snowing) add 1 raining or snowing
=Total1

2=Medium Enhancement—if NOT (Low or High Enhancement)

3=High Enhancement if Total3=3 or 4
(Temperature>32° and <70°) add 1 medium/high temperature
(Humidity>49%) add 1 high humidity (after a rain)
(Wind Speed<10) and (not calm) add 1 low wind
(not raining or snowing) and (not fog) and (not mist) add 1 no moisture
=Total3

Scent Factor Thermals

1=Low Thermals
((Time<8 AM>1 PM) or (Time<3 PM and >8 PM)) or not morning or evening
(Wind Speed>10 MPH) or not low wind
(raining or snowing) or (mist) raining or snowing or mist

2=Medium Thermals if NOT (Low or High Thermals)

3=High Thermals
((Time>8 AM<1 PM) or (Time>3 PM and <8 PM)) and morning or evening
(Wind Speed<8 MPH) and low wind
(Humidity>40%) add 1 high humidity (after a rain)
(not raining or snowing) and (not fog) and (not mist) no moisture

Time Factors

Calculation Predicting Percent Chance of Movement at Time Ranges

Time Factor Morning in Hour Increments
1=2 hours before sunrise 61-120 minutes before sunrise
2=1 hour before sunrise 0-60 minutes before sunrise
3=1 hour after sunrise 0=60 minutes after sunrise
4=2 hours after sunrise 61-120 minutes after sunrise

Time Factor Mid-Day in 2 Hour Increments
1=3 and 4 hours after sunrise
2=5 and 6 hours before sunrise plus time between 2 and 3
3=5 and 6 hours before sunset
4=3 and 4 hours after sunset

Time Factor Evening in Hour Increments
1=2 hours before sunset 61-120 minutes before sunset
2=1 hour before sunset 0-60 minutes before sunset
3=1 hour after sunset 0-60 minutes after sunset
4=2 hours after sunset 61-120 minutes after sunset

Time Factor Dark in 3 Hour Increments
1=3, 4 and 5 hours after sunset
2=5, 6 and 7 hours after sunset plus time between 2 and 3
3=5, 6 and 7 hours before sunset
4=3, 4 and 5 hours before sunrise

Wind Factor

Calculation Combining Wind Direction, Wind Speed, Wind Shift

Wind Factor North (Azimuth 315°-0°−45°)
1=Wind Speed Calm—10 MPH
2=Wind Speed 11 MPH—20 MPH
3=Wind Speed 20 MPH—30 MPH
4=Wind Speed>30 MPH

Wind Factor East (Azimuth 46°-135°)
1=Wind Speed Calm—10 MPH
2=Wind Speed 11 MPH—20 MPH
3=Wind Speed 20 MPH—30 MPH
4=Wind Speed>30 MPH

Wind Factor South (Azimuth 136°-225°)
1=Wind Speed Calm—10 MPH
2=Wind Speed 11 MPH—20 MPH
3=Wind Speed 20 MPH—30 MPH
4=Wind Speed>30 MPH

Wind Factor West (Azimuth 226°-315°)
1=Wind Speed Calm—10 MPH
2=Wind Speed 11 MPH—20 MPH
3=Wind Speed 20 MPH—30 MPH
4=Wind Speed>30 MPH

Wind Factor
1=Wind Speed Calm—10 MPH
2=Wind Speed 11 MPH—20 MPH
3=Wind Speed 20 MPH—30 MPH
4=Wind Speed>30 MPH

Wind Factor Shift
1=Wind Shift last 1 hour
2=Wind Shift last 2 hours
3=Wind Shift last 3 hours
4=Wind Shift>3 hours or no wind shift

Calculations: Action Triggers

Sound Range
1=Short Distance: Sound Factor Wind=3 and Sound Factor Noise=3
2=Medium Distance: Sound Range is NOT Short or Long Distance
3=Long Distance: Sound Factor Wind=1 and Sound Factor Noise=1

Barometric Change

We are looking to see if and when barometric pressure changes effect the deer movement. A slow-moving storm would be about 0.02 to 0.03 inches per hour drop where a fast-moving storm will be about 0.05 to 0.06 inches per hour drop.

In this analysis we are looking to find the hour before the deer movement with the maximum rate of change. This will let us know how long the change took to get the deer to move.

Barometric Drop—when was the largest drop
1=if 1 hour ago was the largest drop in the last 4 hours
2=if 2 hours ago was the largest drop in the last 4 hours
3=if 3 hours ago was the largest drop in the last 4 hours
4=if 4 hours ago was the largest drop in the last 4 hours or no drop

Barometric Rise—when was the largest rise
1=if 1 hour ago was the largest rise in the last 4 hours
2=if 2 hours ago was the largest rise in the last 4 hours
3=if 3 hours ago was the largest rise in the last 4 hours
4=if 4 hours ago was the largest rise in the last 4 hours or no rise

Precipitation Change

We are looking to see if and when precipitation changes effect the deer movement. In this analysis we are looking to find the hour before the deer movement with the maximum rate of change. This will let us know how long the change took to get the deer to move.

We will use the precipitation rate which is the average volume of water in the form of rain, snow, hail, or sleet that falls per unit of area and per hour at the site.

Precipitation Drop—when was the largest drop in rate of precipitation
1=if 1 hour ago was the largest drop in the last 4 hours
2=if 2 hours ago was the largest drop in the last 4 hours
3=if 3 hours ago was the largest drop in the last 4 hours
4=if 4 hours ago was the largest drop in the last 4 hours or no precipitation

Precipitation Rise—when was the largest rise
1=if 1 hour ago was the largest rise in the last 4 hours
2=if 2 hours ago was the largest rise in the last 4 hours
3=if 3 hours ago was the largest rise in the last 4 hours
4=if 4 hours ago was the largest rise in the last 4 hours or no precipitation

Scent Change

We are looking to see if and when the Calculated Influence—Scent factor changes effect the deer movement. In this analysis we are looking to find the last drop or rise in 1 to 4 hours before the deer movement. This will let us know how long ago the change that caused them to move took place.

Scent Drop—when was the last drop in the Calculated Influence—Scent factor
1=if 1 hour ago was the last drop in the last 4 hours
2=if 2 hours ago was the last drop in the last 4 hours
3=if 3 hours ago was the last drop in the last 4 hours
4=if 4 hours ago was the last drop in the last 4 hours

Scent Rise—when was the last rise in the Calculated Influence—Scent factor
1=if 1 hour ago was the last rise in the last 4 hours
2=if 2 hours ago was the last rise in the last 4 hours
3=if 3 hours ago was the last rise in the last 4 hours
4=if 4 hours ago was the last rise in the last 4 hours

Temperature Change

We are looking to see if and when temperature changes effect the deer movement. In this analysis we are looking to find the hour before the deer movement with the maximum rate of change. This will let us know how long the change took to get the deer to move.

Temperature Drop—when was the largest drop in temperature
1=if 1 hour ago was the largest drop in the last 4 hours
2=if 2 hours ago was the largest drop in the last 4 hours
3=if 3 hours ago was the largest drop in the last 4 hours
4=if 4 hours ago was the largest drop in the last 4 hours

Temperature Rise—when was the largest rise in temperature
1=if 1 hour ago was the largest rise in the last 4 hours
2=if 2 hours ago was the largest rise in the last 4 hours
3=if 3 hours ago was the largest rise in the last 4 hours
4=if 4 hours ago was the largest rise in the last 4 hours

Wind Change

What we are calculating here is that during the four hours before the event we are asking, “When did the change last occur?” Veering (clockwise), backing (counterclockwise) and shift (Change in wind direction of 45 degrees or more in less than 15 minutes) are dramatic changes in the wind direction. These will likely effect the deer movement. One example is that deer change bedding areas in the middle of the day if one of these events occur.

Wind change veering—when did the veering winds occur
0=There was no wind veering in the last four hours
1=if 1 hour ago was the last veering wind in the last 4 hours
2=if 2 hours ago was the last veering wind in the last 4 hours
3=if 3 hours ago was the last veering wind in the last 4 hours
4=if 4 hours ago was the last veering wind in the last 4 hours

Wind change backing—when did the backing winds occur
0=There was no wind backing in the last four hours
1=if 1 hour ago was the last backing wind in the last 4 hours
2=if 2 hours ago was the last backing wind in the last 4 hours
3=if 3 hours ago was the last backing wind in the last 4 hours
4=if 4 hours ago was the last backing wind in the last 4 hours

Wind change shift—when did the shift winds occur
0=There was no wind shift in the last four hours
1=if 1 hour ago was the last shift wind in the last 4 hours
2=if 2 hours ago was the last shift wind in the last 4 hours
3=if 3 hours ago was the last shift wind in the last 4 hours
4=if 4 hours ago was the last shift wind in the last 4 hours

Wind Change—
0=No wind change has occurred in the last four hours.
1=One of the backing, veering or shift occurred and two did not
2=Two of the backing, veering or shift occurred and one did not
3=All three of the backing, veering or shift occurred

Snow Change

This action trigger is looking to find out how long it takes for a moderate to heavy snow to cause deer to move.
0=In the last four hours there is no Natural factor Snow as 3=moderate or 4=heavy
1=1 hour ago is the first time in the last 4 hours that Natural factor Snow was at 3=moderate or 4=heavy
2=2 hours ago is the first time in the last 4 hours that Natural factor Snow was at 3=moderate or 4=heavy
3=3 hours ago is the first time in the last 4 hours that Natural factor Snow was at 3=moderate or 4=heavy

Rain Change

This action trigger is looking to find out how long it takes for a moderate to heavy rain to cause deer to move.
0=In the last four hours there is no Natural factor Rain as 3=moderate or 4=heavy
1=1 hour ago is the first time in the last 4 hours that Natural factor Rain was at 3=moderate or 4=heavy
2=2 hours ago is the first time in the last 4 hours that Natural factor Rain was at 3=moderate or 4=heavy
3=3 hours ago is the first time in the last 4 hours that Natural factor Rain was at 3=moderate or 4=heavy

Data Build Process

When a deer enters detection zone 18 of sensor 12, an event is triggered and DeerMapper 10 generates the snapshot of the event.
1. Sensor readings: The sensor data is transmitted to the database as the first step in building the snapshot.
2. File Lookup: Determines GPS location and the deer position related to the trail 20 is determined.
3. Natural factors: The natural factors are retrieved from various web-based databases, Including, but not limited to, the National Climatic Data Center (NCDC).
4. Calculations: The calculated influences are resolved and added.
5. Influences: The outside influences that are maintained by the user are added to the snapshot.
6. Camera image: If there is a camera image available, it is added to the event snapshot.
7. Triggers: Finally the action triggers are calculated and added to complete the snapshot.

The statistical analysis, mapping and prediction are executed live when they are needed.

DeerMapper Analysis—

History generally repeats itself if all the factors, triggers and influences line up with a snapshot that was calculated in the past. This science of analysis is unique to DeerMapper 10 in the volume of data in each event, the data structure, along with multiple events from multiple locations being assessed together to predict future patterns and events. Lesser data complexity can provide only a guess, or intuition, about what will happen. DeerMapper 10 may be compared to weather forecasting, stock market forecasting and football game predictions in that the use of data can be extensive. Future events can be predicted given enough data. Even though the statistical compellations are complex, the conceptual framework and diagrammatic presentation of results produced through them are easy to understand, depend on and apply.

Analysis:—

The user's portion of the analysis is simple, yet tools are available for the technically savvy user. Most predictions are reliable with only one natural factor not requiring many indicators. For example, in a south wind the deer will naturally move to the north field to feed in the late afternoon so they can scan the woods by way of scent and the field by sight. If no other factors fall outside an action trigger there is a high probability of what trail the deer will use and at what time.

The dashboard graphics and report writer present each indicator in the Natural Factors, Calculated Influences, Activity Zones and Outside Influences.

The statistical analysis looks for changing conditions by activity zone, trend and combination of factors to calculate patterns in deer movements. These trends are represented in summary format to quickly identify movement patterns that can be quickly and easily identified.

The determination factors of whether the movement includes young deer, mature deer, doe or buck are the size of animal, pixel count and time of movement. The analysis will recommend camera placement and if used will provide additional verification of the quality of the deer.

Mapping: Each GPS location registered has Event Data associated with it. The GPS locations are added to an interactive Google map. Trends on the map connect GPS locations to draw trails that can be verified with additional sensor placement.

Prediction: The movement factors and patterns are used to match the current weather forecast to determine where the deer will be and when. Probabilities are calculated for each location using past data under the similar conditions.

For the hunter who lives hours from their hunting land, this is a perfect fit. The prediction report will show the best stand locations, the time deer will use the trail and the probability of seeing the deer. The remote hunter can enjoy a live dashboard showing these movements throughout the week as they approach the weekend hunt. Having a wireless camera transmitting pictures to the database is an added verification of what will happen.

DeerMapper Analysis: Calculations

Univariate/Bivariate Statistics—

The bottom line for the user is to discover the top indicators that cause deer to move past any particular sensor 12. DeerMapper 10 looks for the central tendency of each of the 120 indicators and their relationship to time of day. These calculations are of the mean, mode, median, range, variance, max, min, quartiles, and standard deviation of each indicator. The probability is calculated from the values within one standard deviation from the mean.

The mean represents the value of the indicator that is most common. The standard deviation quantifies the amount of variation or dispersion of a set of indicator values. If the standard deviation is close to 0 most of the data is close to the mean, whereas if there is a high standard deviation the data points are spread out over a wider range of values. The lower the standard deviation the stronger the focus of the indicator. This is also taken into account for the calculation.

For indicators that are circular, like wind direction, the normal distribution calculations change. NW is close to N but have azimuth of 0 compared to 315 (opposite ends of the scale) so the distribution results are not correct. So, the frequency counts are used to determine the top wind directions not the mean or standard deviation. For this application it is sufficient to be able to determine the prevailing wind showing the highest counts so applying circular distribution equations is not necessary.

Here are three methods used by DeerMapper 10 to determine the probability of each indicator as having influence enough to be a cause of deer to move past the sensor. A single indicator may or may not be causal as it generally is a combination of several indicators that influence the movement.

Daily Probability—

Daily probability or daily odds are calculated for each sensor as follows:

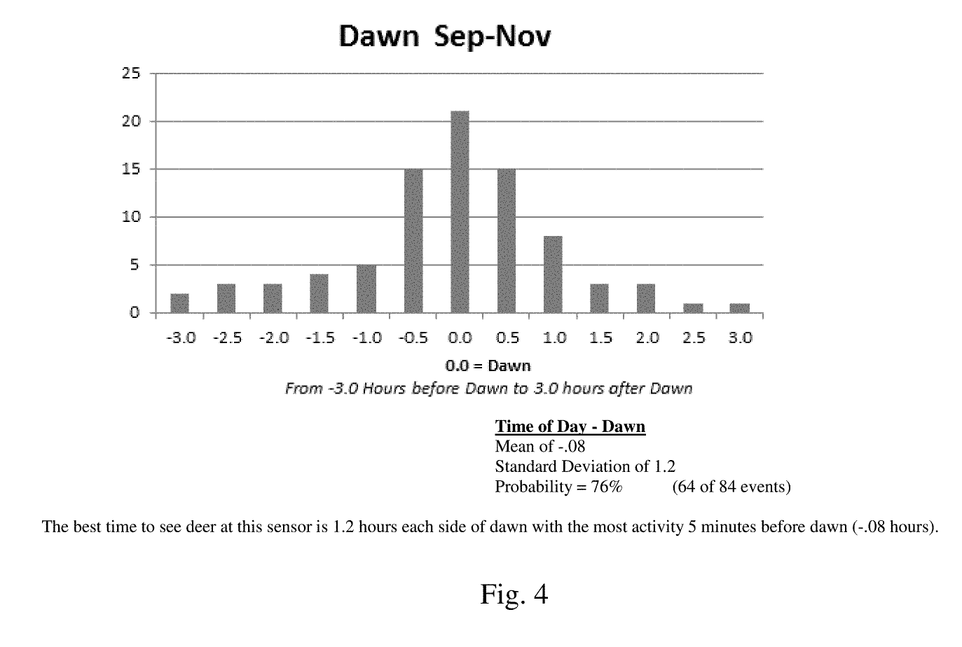

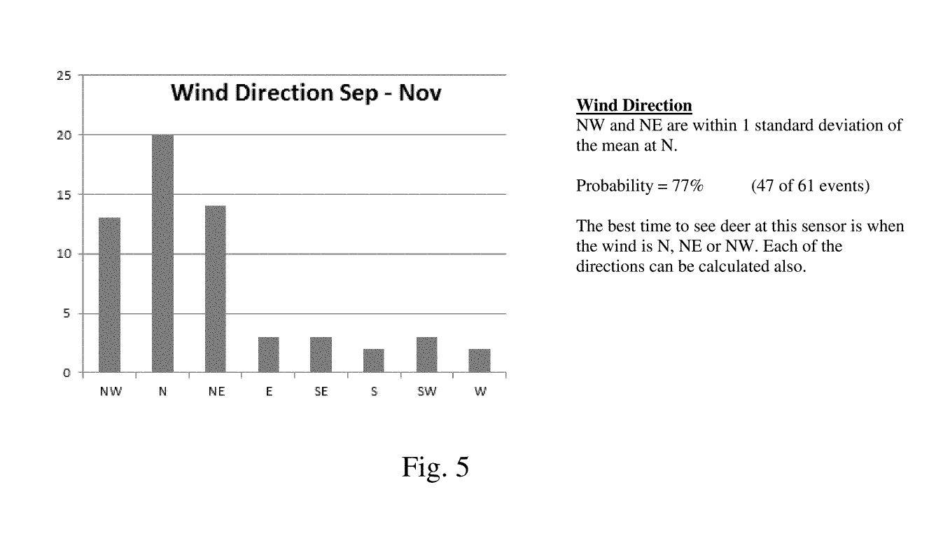

1) Calculate the mean, standard deviation, variance and probability of the Time of Day Dawn, Time of Day Dusk and each of the 120 indicators. The time of day will be adjusted each day by its relationship to dawn and dusk to account for the seasonal change in length of day. For example, see FIG. 4 where there is shown that the best time to see deer at this sensor is 1.2 hours each side of dawn with the most activity being 5 minutes before dawn (−0.08 hours). Now, additionally referring to FIG. 5 it can be see that the best time to see deer at this sensor is when the wind is N, NE or NW. Each of the directions can be calculated also.

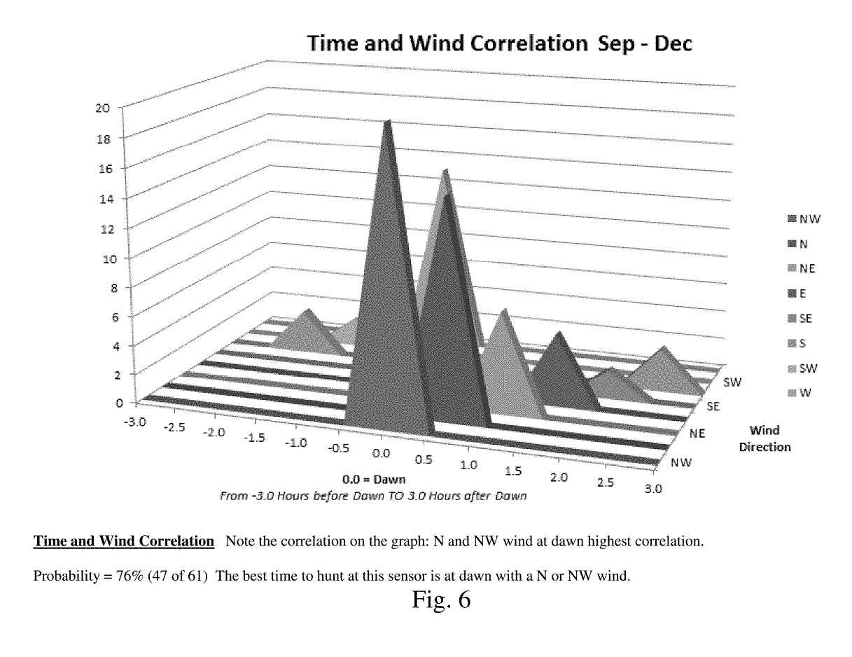

2) Distributions of each of these indicators will then be correlated to time of day to calculate the relationship to the movements to each indicator. Now, additionally referring to FIG. 6 the best time to hunt at this sensor is at dawn with a N or NW wind.

3) The top 5 indicators will be used to illustrate the simplest analysis of a sensor on a selected day.

Top five indicators for Sensor A on Thursday 14th probability of 79% if
Time=1.2 hours either side of dawn 76%
Wind Direction=N, NE, NW 77%
Barometric drop=4 84%
Precipitation drop=4 88%
Wind factor shift=4 72%
What this also says is that the best time at this sensor is when there is stable weather i.e. little or no barometric change, precipitation change or wind shift.

The majority, say ninety percent of the statistics done by DeerMapper 10 is Univariate/Bivariate. Multivariate is reserved for biological or mathematical research. This research will provide published papers for the users to gain even more insight into the movement of deer but not have to do the rigorous analysis required by multivariate analysis.

Multivariate Statistics—

To further expand the insight into the causes, DeerMapper 10 provides methods to establish relationships between multiple indicators. The analysis here is between multiple variables simultaneously to look for correlations, comparisons and explanations from multiple points together.

Some of the indicators will become dependent on one another and some will remain independent and not follow a relationship. As more data is applied more insight in these relationships is formed.

Because of the complexity of these calculations they are not listed here. Also, the actual analysis will require specialized statistical software.

Multivariate statistics is mainly reserved for biologists and mathematicians to do research for publication. The assumption is that the volume of data being received will spawn many research projects.

Clock Analysis Tool—

Time is a central focus of the DeerMapper 10 analysis. DeerMapper 10 provides event data analysis for each sensor 12 location. The hunter uses that analysis to determine when the deer will move past each sensor 12 in the future. DeerMapper 10 determines the probability of when deer will pass in front of each specified sensor. The DeerMapper 10 Clock is one of the simplest tools available to the hunter to illustrate the probability for each location of when the deer will pass. This clock provides a path to the more complex calculations and data to educate the hunter to why the deer are moving past. DeerMapper 10 is based on empirical data and statistical analysis. But, with this empirical data in place, the hunter is better equipped to use all of his instincts and intuition for the hunt.

The clock analysis tool is the way for the hunter to quickly illustrate the best probability to determine what sensor location to hunt and at what time.

The Sensor List shows the best times, AM and PM, to hunt by a sensor by a selected date. The probability calculation of deer passing the sensor can only be predicted up to seven days in advance. The less number of days into the future will give the best quality prediction. The weather data used is dependent on the weather prediction for the location.

Deer Mapper past data is based on fact, events that were precisely measured. The prediction dependability will improve as more data is gathered. Beyond seven days DeerMapper 10 cannot be precisely predicted because there is not accurate indicator values available beyond that.

Here is a sample future prediction for all sensors 12 by day:

Sensor ListSensor: All Scale: By Day Today: Wed Oct 21
When: Fri Oct 23

| | AM | | | PM | | |
|---|---|---|---|---|---|---|
| | | | Deer | | | Deer |
| Sensor | Time | Probability | Count | Time | Probability | Count |
| Sensor A | 6:30 AM | 23% | 4 | 5:00 PM | 80% | 3 |
| Sensor B | 7:30 AM | 32% | 2 | 5:30 PM | 80% | 2 |
| Sensor C | 6:00 AM | 11% | 3 | 6:30 PM | 89% | 5 |
| Sensor D | 7:00 AM | 74% | 1 | 5:00 PM | 20% | 1 |
| Sensor E | 7:30 AM | 81% | 3 | 5:30 PM | 31% | 2 |

Using the above report the hunter would select a sensor, date and scale. If the date is in the future the system 10 looks up the forecast, compares it to the historical data to determine the percent and number of deer expected at each specified time.

The scale is by day, week or hour. If a week is selected the days will be divided by morning, mid-day, evening and night. If a day is selected it is divided by hour. If the hour is selected there will be three hours on the display divided by quarter hour periods.

Here is an example future prediction for one sensor by the hour:

Sensor ListSensor: Sensor C Scale: By Hour When: Fri Oct 23 Today: Wed Oct 21
Forecast to match: Temperature: L42⁰ H56⁰ Humidity: 74% Dew Point: 40⁰ Daylight 10:37
Wind 22 mph SE UV Index 2-low Moon Waxing gibbous, Visible: 79% ↑, Age: 10 days
Precipitation: 20% Change: Wind +10 SW Change: Temperature +15

| | | Deer | | | | Deer | |
|---|---|---|---|---|---|---|---|
| Time | Probability | Count | | Time | Probability | Count | |
| 12 AM | 1% | 0 | | 12 PM | 1% | 0 | |
| 1 AM | 1% | 0 | | 1 PM | 1% | 0 | |
| 2 AM | 1% | 0 | | 2 PM | 1% | 0 | |
| 3 AM | 11% | 3 | | 3 PM | 1% | 0 | |
| 4 AM | 1% | 0 | | 4 PM | 1% | 1 | |
| 5 AM | 1% | 0 | | 5 PM | 56% | 5 | 5:55 sunrise |
| 6 AM | 9% | 3 | | 6 PM | 89% | 5 | |
| 7 AM | 12% | 3 | 7:17 sunset | 7 PM | 37% | 5 | |
| 8 AM | 8% | 3 | | 8 PM | 10% | 1 | |
| 9 AM | 1% | 0 | | 9 PM | 1% | 0 | |
| 10 AM | 1% | 0 | | 10 PM | 1% | 0 | |
| 11 AM | 1% | 0 | | 11 PM | 1% | 0 | |

User Experience

Sensor and Gateway Registration: When the user receives their kit they are required to register the kit with DeerMapper 10. To do this, they create an account on the DeerMapper website. Once logged in, they enter the serial number of the kit under their account.

This registration assures that the sensor setup, testing and data collection will only work with the sensors 12 and gateway 22 registered under that user account. If a sensor 12 or gateway 22 is stolen, it cannot be set up without the user account login that matches the registration. The registered user has access to DeerMapper technical support, repairs and exchange services. DeerMapper support service includes online access to the registered user's sensors 12, gateway 22 and database for maintenance only if the registered user allows access.

Gateway Location Determination: Gateway 22 is the first device (node) to be placed on location. Once it is in place, sensors 12 are placed within the range of gateway 22 or within range of a chaining of sensors 12 to gateway 22.

Gateway 22 may be placed at least one half mile from one of sensors 12. Sensors 12 are in a full mesh network 14 allowing the signal to pass through several sensors 12 to get to gateway 22. This style of network not only increases reliability but also increases range. Gateway 22 is not a sensor but can be placed outside if that is the only option. If a building with power and WIFI is within that range it is best to keep it indoors. Indoors, gateway 22 does not rely on batteries nor does the user need to use a cellular service. There is a monthly fee for the cellular service if the gateway 22 is used without access to WIFI.

The user can then leave the system set up without returning until after the season is over. The batteries are designed to run without interruption for one year. Extended batteries can be purchased that will last over one year. It is next to impossible for intruders to know that the system is present since sensors 12 are near to invisible with no sound or lights. The design is so that there is no human presence in the area to provide as natural of movements as possible.

Sensor Location Determination: As each sensor 12 is being placed, it is important for the user to check, by way of a PC, tablet or phone app 16, the RSSI (Received Signal Strength Indicator) and LQI (Link Quality Indicator) of sensors 12 and gateway 22 to show the current signal strength of each node on the network 14. This is especially valuable in hoping from sensor to sensor along the mesh network 14 to maximize range. Multi-hop can be tested live on location to assure no loss of signal strength and signal quality. Networks 14 do not limit the hops. With a solid ½ mile range ten hops could extend the range of the network to five miles.

To place a sensor, the user can see its signal strength and quality to gateway 22 to make sure it is not too far from the network 14 and has a weak or depleted signal. This is a continual read and as each sensor 12 is being placed the entire network can be tested for strength.

Where to place the sensors 12 can be as simple as wherever there has been a deer stand. It can also be as complex as understanding where the bedding, feeding, breeding and watering locations are, so as to place sensors 12 strategically along the travel and escape routes to and from each location.

The ideal number of sensors 12 to cover a forty acre area is ten with the least number being five. The system 10 can work with one sensor but is limited because deer do not travel the same route every day. Therefore, the system comes with the minimum recommended five sensors and the user can add packs of five sensors.

Sensors 12 can easily be moved from one location to another but this limits the accuracy of the sensor for two reasons. First, is that it reduces the volume of data, which limits the accuracy of the trends. Second, is that human presence will affect the natural deer movements for at least three days. The longer a sensor 12 is active the more dependable and consistent are the trends.

Deer trails 20 are generally one way trails. This means that the sensor can be placed with the sun at its back, when it is expected that the deer will use the trail, with the tree blocking the sun. This is not necessary, but if the sun is shining directly into the sensor it may reduce its effectiveness. The sensor should be placed between 20 and 30 feet from the trail. It is important to aim the sensor perpendicular and at three feet high to the trail. Sensors 12 come with camo covers that match the tree type and are not easy to see as they do not have any lights, buttons or moving parts. They are small, silent and visually blend into the bark of the tree.

Once set up, their detection zone 18 will be about 10-12 feet of the trail providing a dependable window to detect the movement. The user will start the DeerMapper phone app and walk down the trail into the detection zone 18. Once in the zone, the sensor will detect the user and send an event to the gateway 22. Gateway 22 will update the database which will be picked up by the mobile phone app 16. This is all the user needs to do to set up each sensor. Note that the mobile phone 16 will provide the sensor GPS position as to where the deer will be when detected, not by the sensor.

System Maintenance: The user can see the battery level of all of sensors 12 and gateway 22 at any time online. There is a table showing the battery levels of each device for each event to illustrate battery usage for each device. The batteries are designed to last for the full hunting season without a need to go on location to check the levels or change the batteries.

Each year, the user can bring the sensors to the dealer for a battery change or exchange for new sensors. It is important for DeerMapper 10 to always be up and the user not have problems.

From a PC, tablet or mobile phone 16 the user can change the transmission frequency from live to hourly, daily or as needed. Even in live mode, the battery will last the full season but the time can be extended even more by changing the transmission frequency to daily. During non-hunting days, it is sufficient for a daily transmission. To extend battery life even further the nodes will automatically enter sleep mode when there is inactivity.

The user can see the RSSI (Received Signal Strength Indicator) and LQI (Link Quality Indicator) of each node (sensors 12 and gateway 22) at any time by way of a PC, tablet or mobile phone 16. This is especially important at setup to get the strongest signal and maximum range of the mesh network 14.

The data analysis is by the recorded GPS location on trail 20 and not from sensor 12, as sensors 12 can be moved. The longer the user has a live sensor at a GPS location the stronger is the analysis. Each indicator has a separate file to adjust the size and intervals of the range of values. Also, for some indicators the values could be from a table maintainable by each indicator. The system comes with standard values but can be adjusted by the user.

Reports out of the database of events can be downloaded to Excel for further analysis.

Analysis: See the section “DeerMapper Analysis” for the user experience of Analysis.

Hunting: The trend of today's hunters is that they sit along trails waiting for deer instead of participating in organized deer drives. This style of hunting requires that the hunter pattern the deer to predict which trail gives them the best probability of success with minimum time on the stand. This provides an additional challenge for hunters whose land is too far away to scout with sufficient frequency to be able to predict the time and place to sit.

When a weekend hunter plans a hunt at a remote location they will first determine the hunt times, say Friday evening. They login to their data on DeerMapper 10 and select a new hunt. They will enter the time of the hunt and DeerMapper 10 will locate the sensors 12 with the highest probability of deer movement. If there are also trail camera photos the hunter can see the quality of the deer traveling past the sensor.

The hunter would then select the location and hunt there. The hunter can also better prepare for the hunt by scanning the 360 degree photo of the deer stand they had taken when they set up sensor 12.

With the present invention it is likely that the prediction will be so accurate that the hunter will know, within minutes, when the deer will come down the trail.

The hunter can keep the mobile phone 16 with them on the stand and see live movements occur in any of their sensors 12 while they are hunting. To do this it is important to first check the hunting laws in the area concerning electronics use on the hunt. The next morning hunt can be selected in the evening before the hunt. The closer the analysis to the hunt the better the prediction.

Gaming: See the section “Summary” and “Gaming” for the user experience of gaming.

Technology Currently Available in the Market

The wireless trail camera is used by many to obtain pictures of deer. The problems with this technology, which DeerMapper has overcome, include cost, warranty (repairs), battery life, RSSI (Received Signal Strength Indicator), LQI (Link Quality Indicator), camouflage (lights and size), security (stolen cameras), image storage capacity, accurate GPS, lack of data, no networking, no database, complex setup and low cellular signals.

There are four types of technology used by these camera companies listed here with example products of each technology.

1. There are Wireless Trail Cameras that use SIM cards to text pictures to a cell phone or email.
The purpose is to see a picture immediately without entering the woods.
The user will then name the picture, add documentation and copy it into an Image Handling System.
This process is manual and is not designed to automate the process at multiple locations.
The pictures are not sent to a database for analysis with other picture events.
Wireless cameras are not cost effective for multiple locations.
Wireless cameras are not part of a network but are designed as a stand-alone.

Examples of these Types of Product:
SpyPoint Live Cameras are fully configurable online by way of mySPYPOINT
   Mini (text, email), mini4G (4G cellular network (HSPA+) on the mySPYPOINT server),
   Mini4GV (4G EV-DO cellular network),
Covert 3G Code Black
Bushnell Trophy Cam 3D wireless

2. Trail Camera Survey and Image Handling Systems are a common service provided by camera companies.
The hunter sees a deer and registers a sighting in the app, unfortunately human presence puts deer on alarm
Data gathering takes time, even when the picture is sent by way of text or email
The app does look up the weather data to the event but it is difficult for the user to know the exact time and GPS for the event as it is entered upon sighting.
The data is not automatically captured by way of multiple sensors 12, through a gateway 22 directly to the online database.

Examples of these Types of Product:
SPYPOINT Camera and photo Management System. Online organization of phots, keyword tagging, limited weather data (temperature, wind direction, moon phase) and statistics to predict hunts
Buck Advisor's Trail Camera Survey
Hunter's Club.com W.I.S.E
   WISE is deer scouting and management software for your computer that syncs your trail camera images and your field observations with the weather and moon phase. It will suggest a stand for you to hunt based on the upcoming forecast.
DeerLAB Tracks specific deer across multiple cameras. They include some weather data but the main statistic is based off time.

3. Wireless sensors ping a remote receiver to alert the hunter of a passing deer
This is against the law in many states where radio communications cannot be used to take deer (during a hunt).
Example in Minnesota, “Using walkie talkies, cell phones, remote control of other radio equipment to take big game or small game is unlawful.”
This is a single event process and does not transmit multiple events to a database
The DeerMapper 10 system protects the hunter by allowing them to remotely turn off the sensors during the hunt.

Sample Products:

SPYPOINT Motion Detection System—Up to 1,000 feet and requires a receiver.
Articles about the laws of using electronic devises to let a hunter know where a deer is during the hunt.
   These laws are changing as new technologies like drones are available. States effected are: CO, IA, MI, MN, MT, OH, SD, UT and WI.
   The Pope & Young and Boone & Crockett view “fair chase hunting” cannot include the taking of animals, “by the use of electronic devices for attracting, locating or pursuing game or guiding the hunter to such game”.
   The DeerMapper app can easily turn off the sensors during the hunt so the hunter is not affected by these laws. The action of turning the sensors off is captured in the log to prove the hunter did not use electronic devices during their hunt. Even when the sensors are off they continue to collect events, which will be uploaded, to the database as soon as it is back on. This protects the hunter from breaking the law, yet does not miss any movement events.

4. The camera can download pictures to a cell phone, or black box, hundreds of feet away with no SIM card.
The value is that it does not require SIM cards or monthly processing fees
If you have the cell phone and are hunting, this may be against the law.
Natural movements of deer within hundreds of feet of a person or a home accounts for a very small sample of deer movements. Therefore it provides a small sample of data for a property.

### Sample Products:

Kodiak Series Trail Camera—The first trail camera that allowed you to download photos and videos to your smartphone from hundreds of feet away.
SPYPOINT TINY 4G—These cameras can all work with a BLACKBOX wireless backup system. Retrieve your photos while staying away from the monitored area. Can set up the black box to connect up to 10 cameras at 500 feet away to retrieve photos.

Problems of other systems overcome by the present invention include:
Using cameras to upload images—not sensor events.
Using a single device—not multiple sensors in a full mesh network 14.
Having no data enhancement process like factors, influences or triggers.
Not including a complete system or network that works together—sensor, gateway 22, database.
Not gathering data for the purpose to study deer movements.
Not tracking deer on a trail.
Not tracking deer movement but tracking deer when they come to a feeder.
Not having sufficient data nor data analysis to predict deer movements.
Using a single device that reads GPS, temperature, barometer then transmits it instead of transmitting the event, then looking up the data on the web to match the event.
Not moving data to a database for statistical analysis.
Not transmitting live deer data to a device on a deer stand—one issue is that is against the law.
Cannot determine RSSI (Received Signal Strength Indicator) and LQI (Link Quality Indicator) for the setup live on location to assure strong signal in unique environments.
Cannot capture live deer movements in remote areas where no cellular or WIFI is available. DeerMapper transmission frequency can be set to ‘as needed’ so the user can download, on location, the events directly to a mobile phone, tablet or PC.
Cannot capture live deer movements over large acreage, even miles, without human intervention.

Human data generation is inadequate so the wireless trail camera lacks data. The trail camera may provide a GPS location, but it represents the location of the camera, not the deer. The battery level, pixels, animal size, distance from camera, direction of travel and speed of travel are not included in a trail camera image. The cost of the camera is at least 10 times that of a sensor 12, and they are not practical for multiple locations.

Another embodiment of the present invention relates to an animal tracking system, and, more particularly in this document, to a deer movement analysis system for hunters that do use imaging devices.

Additional Terminology:
Sensors, gateways, relays and imagers are custom devices within the present invention.
The sensors, relays and imagers will also be referred to as endpoints in this document.
The term ‘network’ is used to describe a single gateway communicating under one radio frequency with endpoints that are registered under the same user.
An ‘event’ is an animal movement captured by a sensor or imager.
A ‘stripped image’ is an image with stationary non-animal things like trees, branches, brush and grass stripped out (See FIG. 1 and FIG. 2). The animal is proportionately centered into a standard 5-yard view where all animals are of relative size. The present invention also unpacks the following attributes out of the picture to build a complete data representation of the picture;
   Direction of travel
   Type of animal (deer, fox, coyote, hog, turkey, bear)
   Gender (if it is a deer) Buck or doe
   Distance to the Imager
   Weight of the animal
It is contemplated that other items will be added to this list of attributes.
A ‘notification’ is a data set including the device id, date/time of event, and direction of travel. The normalization does not include the stripped image nor its attributes. The purpose of the notification is to provide live immediate notification to the user that there is an event. The time between an event and a notification is 1 to 3 seconds.
A ‘snapshot’ is the data representation of an event including the notification, stripped image and image attributes in one data set. The full snapshot is send immediately after the notification and will take about 30 seconds to transmit to the database.

Relay—

A relay is a sensor with the PIR module and SD Card removed. Relays are positioned to connect to endpoints that are outside of the range of the gateway. Relays receive event transmissions from those endpoints then sends the events to the gateway or another relay. Relays are repeaters set up in a multi-hop scenario. Imagers, sensors, relays and gateways in the present invention form a mesh network that is self-forming and self-healing. The network is self-forming in that each endpoint must match the registration of the gateway and find the best route back to the gateway via direct or through relays. The network is self-healing in that if any device enters the network or changes its location the network will adjust for optimal routing. The advantage here is that the user does not have to use a complex setup process but simply turns on the devices and they find their own best way to work together. Also, it would be very difficult for a user to set up the network as efficiently as it can through self-forming and self-healing.

If a device enters the network's radio frequency but does not have a verified registration the gateway takes charge and changes the radio frequency to self-form the network until there is no device using the same radio frequency that does not have a verified registration.

After the self-forming is settled each endpoint and relay will examine the signal strengths required to reach its assigned relay or gateway. The endpoints then adjust their own power, within the range of one-tenth watt to one watt, to match their range and maximize battery life.

The single endpoint radio range at the time of this writing was 1 mile. The network radio range is determined by how many multi-hop relays extend in any direction. The recommended network for greatest efficiency would be to extend no more than one hop. Efficiency of the configuration is determined by the load on the relays closest to the gateway. After five multi-hops, it is beneficial to add another gateway to break the setup into two networks.

Imager—

An imager is a sensor that takes a picture and stores it on an SD card immediately followed by a notification radioed to the gateway. Simultaneously, in a separate radio channel the full snapshot is radioed to the gateway. A gateway configured with a single hop network can handle up to 250 imagers, sensors and relays in a four-mile diameter radio network designed to gather animal movement events. If the gateway is placed 20 feet up on a tree, building or hill the range will double.

The hunter can set up the gateway to transmit via cellular or WIFI to/from the cloud database. If there is not cellular or WIFI coverage the hunter can either capture the data within 100 feet from the gateway with Bluetooth and a mobile phone or simply pick up the SD card. If there is no cellular or WIFI and the gateway is elevated, the hunter can capture the data from the ground below the gateway using a mobile phone.

Imager Purpose Vs Trail Camera Purpose—

The present invention's imager takes a picture then unpacks attributes out of the picture discarding some and keeping some leaving a stripped data image of the deer. The valuable attributes, and the stripped data image form a data snapshot of the movement event and are transmitted via radio to the gateway. The gateway then transmits the data snapshot, via cellular to the present invention's cloud database. These snapshots are the basis of the data structure used for deer movement patterning and prediction.

The data included in the snapshot is:
1. Device ID
2. Date/time
3. Direction of travel
4. Type of animal (deer, fox, coyote, hog, turkey)
5. Gender (if it is a deer—buck or doe)
6. Number of animals
7. Distance to the Imager
8. Weight of the animal
9. Stripped data image: Animal image without the background, proportioned into a standard image size as though the animal were 5 yards from the imager

The discarded data includes:
1. The pixels on the picture that did not change. The PIR is triggered by movement and heat so it would eliminate stationary non-animal things.
2. Trees, branches, brush, grass

Trail camera pictures are too large for a radio network transmission or cloud database storage so they are generally stored in file folders making deer movement patterning and prediction very difficult.

Trail camera innovators focus on picture quality with 20MP color pictures resulting in a struggle with battery drain, long flash time and slower shutter speeds of over 0.2 seconds. The present invention's imager uses a global shutter with less than 0.1 second shutter speed and B&W images of less than 20K pixels. Imagers produce a snapshot of picture attributes and high clarity stripped data image of the deer designed for a computer to do statistical analysis not direct human interpretation like a trail camera picture. The imager shutter is designed to capture rapid movement sequences, like a running deer, without distortion resulting in exceptional clarity.

This difference of purpose, data or pictures, separates the present invention's imager from a trail camera.

This does not mean the imager does not store pictures. It stores picture on the SD card then builds the snapshot of picture attributes and uncovers the stripped data image of the deer for analysis. The hunter can use the present invention's web app from anywhere to upload a selected original imager picture from the SD card or they can retrieve the SD card to browse the original pictures.

A trail camera picture has limitations. It cannot tell why a deer is there, where it came from or where it is going. The imager transforms pictures to snapshots for analysis.

Trail camera pictures in file folders alone restrict the ability to visualize deer patterns. Using the present invention, the hunter can study the deer herd using the present invention's visual and analysis tools to build connected patterns of data without ever entering the woods. With only 6 AA batteries the imager will last six months.

Double Lens Imager—

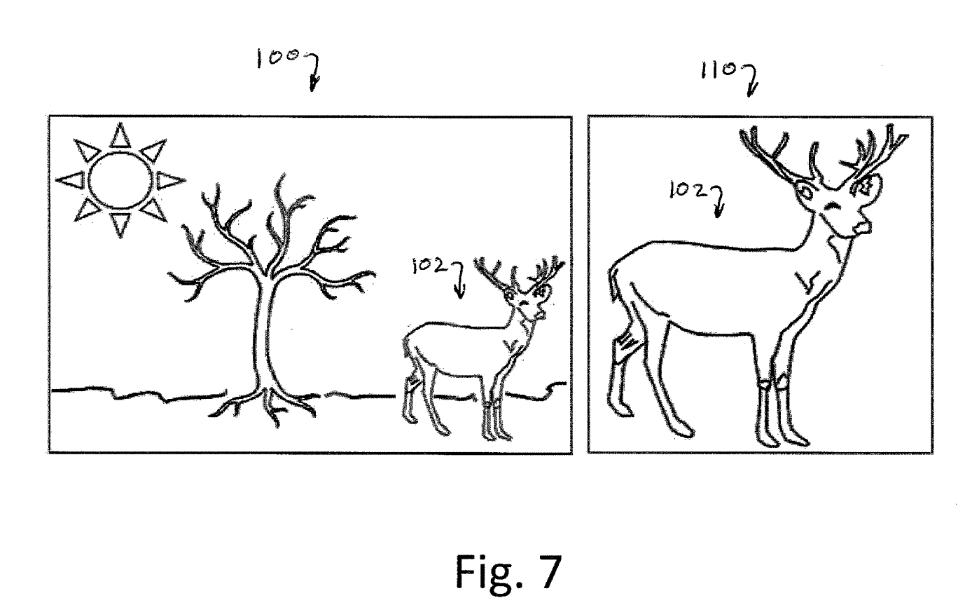

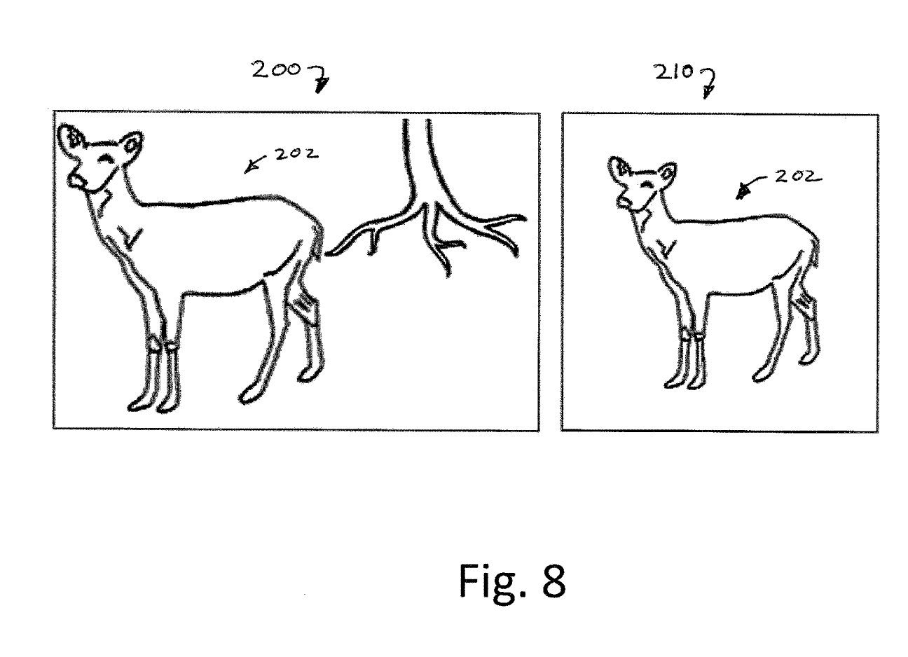

Now additionally referring to FIGS. 7 and 8, in image 100 a deer 102 is 20 yards from the imager so it looks smaller than a deer 202 in image 200 of FIG. 8 that is, for example, 3 yards from the imager. But the animal 102 is larger than animal 202.

After unpacking the valuable attributes, the imager removes the background and proportions the image of deer 102 as though it were at the standard 5 yards as the imager produces image 110. The imager was also able to identify that animal 102 is a deer 102, that it is 20 yards from the imager, that the direction of travel is left to right, and that the animal has antlers and that it weighs 200 pounds.

From image 200 deer 202 proportionally takes up more area of the image than deer 102 did in image 100, but deer 202 is 3 yards from the imager so it looks larger than deer 102 in FIG. 7 that is 20 yards from the imager. After unpacking the valuable attributes, the imager removes the background and proportions deer 202 as though it were at the standard 5 yards. The imager also identifies that animal 202 is a deer 202, that it is 3 yards from the imager, that the direction of travel is right to left, and that the animal 202 has no antlers and it weighs 150 pounds.

The imager unpacked both pictures 100 and 200 separating out the valuable attributes and discarding the background resulting in images 110 and 210. The imager isolated the stripped data images and set up the proportions as though both are at 5 yards and fill the same sized frame 110/210. Now the hunter can scroll through the stripped data images and see clear, isolated images of the deer proportioned by size.

Double Lens Imaging Process—
1. The imager's PIR sensor is divided by a vertical metal strip into two horizontal parts. The animal's direction of travel is determined by which half is activated first.
2. The single lens imager takes a picture when the deer is in the PIR detection zone and another picture after it is gone. The first picture is stored on the SD card.
3. The stereo imager takes a picture from each lens when the deer is in the PIR detection zone and again after it is gone for a total of four pictures. The first picture from the top lens image is stored on the SD card.
4. Immediately, a notification is sent to the gateway then to the cloud which triggers a mobile phone notification of the movement including time, direction of travel and which device. This will reach the mobile phone within 1 to 3 seconds. Notifications will arrive within this time frame even if several images are backed up in the transmission queue.
5. The gateway scans all devices once every 2.5 seconds for notifications. In that 2.5 seconds 1 second is set aside to transmit the images. This assures instant notification of an animal movement.
6. In both the single and double lens imagers the background of the second picture is digitally subtracted from the first picture resulting in an image only showing the change. The resulting image will isolate the deer by removing the trees, brush, ground or any other stationary object. Even branches that are moving will be removed by this image process.
7. The stereo imager then measures the distance between the back of the deer from the top lens image from the back of the deer from the bottom lens image. Using this measurement, the imager can now calculate the distance to the deer.
8. Knowing this distance, the imager can now size all images to the same proportions with the deer isolated in the middle of the image appearing to be the same distance away. From these measurements, the imager can also determine body dimensions, calculate the weight and measure antler size.
9. The resulting image and body dimensions and weight is then transmitted to the gateway in its 1 second interval. This may take several intervals depending on how many images are in the queue. So, the image transfer may take up to 20 seconds to reach the database.
10. Further image processing, like animal type, antler scoring and number of animals, is done on the present invention's server.

An advantage of the vertical lens design of the present invention is that the imager box is tall and narrow, which looks more natural on a tree than a wide shorter box.

Image Uploads of Trail Camera Pictures—

The Present invention's web and mobile app provides a means to import pictures from trail cameras into the present invention's data structure for patterning and prediction.
1. The trail camera images first need to be placed into folders sorted by camera location.
2. The hunter will be asked for a camera name, GPS location and direction to the trail to add the device to the present invention's database of devices. Instead of type Sensor, Imager, Relay or Gateway it will be named Camera.
3. The hunter can use the mobile app while standing at the camera location and point the mobile phone at the trail to retrieve the GPS and direction to the trail. This is done to improve the accuracy of what was entered manually in the registration of the Camera.
4. During import, image processing is used reduce the image size to 20K, center the deer, and crop the picture to reduce the background. It is not yet possible to fully eliminate the background through subtraction with only one image.
5. When the image is received into the database the present invention will extract the date/time from the image Meta data combined with the GPS from the import to retrieve the weather data. To assure accuracy, the present invention's database has several years of hourly historical weather data from 6,000 locations.

Image Tagging—

For uploaded images of the prior art, the type of animal, size of animal and number of animals are not available. Using the present invention's image tagging the hunter will be able to scroll through these images and modify those data fields. Also, if the hunter wants to name specific animals tagging will be used. This is also available to imager images to add the deer identity and modify other attribute fields.

The hunter is able to scroll through the untagged images on the present invention's database to easily modify
Direction of travel
Type of animal (deer, fox, coyote, hog, turkey)
Gender (if it is a deer—buck or doe)
Number of animals
Deer Identity (identify and name specific animals . . . )

Authentication—

All devices contain an internal and unchangeable ID registered in the present invention's database. Registration assigns the device to the user at registration. The Gateway must be the first device registered by a logged in member. When the gateway is powered up and they have not been registered the web app asks for the user to enter the ID stamped on the inside cover of the gateway. If the device is already registered to someone else the member must call support to gain security clearance to re-register it. The gateway cannot be used except by the registered owner of the gateway.

The logged in member must register each device by entering in the device ID stamped on the inside cover of the device. When powered up the device automatically connects to the closest gateway that is registered by that user. Until the device is registered to a local gateway it will keep searching until it finds its own registered gateway. If the gateway hears from an endpoint not registered to itself it will change the radio frequency of the network and self-heal until the interference is gone.

Device Settings—The user can change any of the settings on all or a specific device by using the present invention's web or mobile app. These settings include:

All Devices

| | | |
|---|---|---|
| Low Battery Alarm Hunter | % | default 10% |
| LORA spread factor | 6-12 | |
| LORA power | 2-14 | |
| Radio Amp | on/off | default on |

Relays:
Signal to Noise Ratio Averaging read it not set it

Imagers or Sensors:

| | | |
|---|---|---|
| Image delay Hunter | seconds | default 30 seconds |
| PIR Signal Strength Hunter | 1-100 | when it trips |
| PIR Delay Time | 2-255 | tenths of seconds |
| PIR trigger to camera | | |
| HD image size Hunter | Low/Medium/High | default high |
| Flash Hunter | on, off, auto | |

Gateways:

| Signal to Noise Ratio Averaging | | read it not set it |
|---|---|---|
| Operating Frequency of Radio Network | | read it not set it |
| Image delay | seconds | default 30 seconds |
| PIR Signal Strength | 1-100 | when it trips |
| PIR Delay Time | 2-255 | tenths of seconds |
| PIR trigger to camera | | |
| HD image size | Low/Medium/High | default high |
| Flash | on, off, auto | |

Bait station mode: on, off
Endpoints are generally placed on deer trails used by deer for travel between feeding, bedding and water. If the endpoint is placed by a bait station the deer stay, move around and eat for extended periods of time. This will trigger frequent movement events and skew the statistical analysis.
In bait station mode, the imager will only generate an event for the first appearance of deer at the station after at least an hour of no deer. At 15 minutes intervals, the imager will count the deer movements and transmit the notification with the count at the bait station. If there are no longer deer at the bait station for 15 minutes the cycle will end.
This will separate the mingling of deer at the bait station from their arrival and balance the statistics.

Dashboard—

The present invention's web and mobile app utilizes the following seven dashboard visuals to help the hunter determine where to hunt and when to be there. These analysis tools will combine both the imported images and the images received from the present invention's devices.

1. Prediction—

this visual is available on the present invention's mobile app
The home screen of the Mobile App will display the next AM and PM percent prediction based on the prediction analysis. If the user clicks either AM or PM the system will provide access to the following analysis visuals titled Where, When and Wind Direction Notification.
Where: This visual determines the endpoint with the highest probability of deer movement during the next sunrise or sunset. The present invention will count the highest number of events in the historical data for each endpoint by the forecasted wind.
   Each of the ‘where’ visuals below use a scroll bar for the user to quickly visualize a day or a week.
   Hot Spots: A heat map of all endpoints visualizing the number of events, by forecasted wind, for either the next sunrise or sunset.
   Wind: A map showing all endpoints labeled with the percent of visits based on a scroll bar by date/time. It will also display the wind as arrows across the map by direction and their length by wind speed.
   Average: This visual is for a specific endpoint showing its detection zone and the average number of events per day for the past week.
   Weather: The weather matching the date time on the slide bar will be displayed in this visual. The scroll bar can represent either past or forecasted day/time.
   Wind vs Deer: An image of a deer shows the travel direction compared to the wind direction changing as the scroll bar moves through time. Also, a visual showing the frequencies of each direction of travel for a day by each wind direction is included.
   Stripped Images: As the user moves the scroll bar through time, the stripped images display matching the time. The images are sorted in the order they occurred at the endpoint.
   Summary: For each endpoint, the summary below will be displayed. The endpoints will be sorted in the order of hot spot percentage by the forecasted wind. The app will display the property name, date, sunrise or sunset, endpoint name, forecasted wind, the percent of the events by that forecasted wind, the total events and the number of events by that forecasted wind.
When: The When visual determines the highest probable time, the deer approach the endpoint at sunrise or sunset.
   Deer tend to move earlier or later depending on weather factors like total rain, total snow, temperature, humidity, dew point, wind speed, UV Index, visibility, cloud cover, pressure, severity, moon phase, moon age and total hours of precipitation. The invention calls these weather factors influences.
   To determine the best arrival time at an endpoint the present invention first calculates the average arrival time for the endpoint at the forecasted wind direction.
   Next, the present invention selects the top three influences based on their specific average arrival times. This will provide the hunter a more precise arrival time but also a learning process to see what factors effect arrival time. For the selected endpoint, the visual display includes at least these items in the following example;
      Average Arrival 4:34 pm
      Top 3 Weather Influences
         Pressure: 29 IN 4:02 pm (−32)
         Cloud cover: Overcast 4:10 pm (−24)
         Wind speed: 20 mph 4:14 pm (−20)
Wind Direction Notification:
   Deer will move when the wind changes direction. No matter what time of day it is, they will be on the move immediately after the wind direction changes. To notify the hunter of this possibility the present invention will add a line to the prediction display. If the wind is forecasted to change at least 90 degrees during the 12-hour forecast, the following two lines will be added to the prediction.
   Wind Direction Change Notification from S to NW at 2 PM.
   The deer will move immediately after that change.

2. Deer Clock—

this visual is available on the present invention's web app
The objective of this visual is to get the hunter to think about time from a deer's perspective.
Unlike humans, deer have no knowledge of hours, days, weeks or months. Deer respond to seasons, sunrise, sunset, sun/moon and wind direction not clocks or calendars. The present invention refers to these factors as influences.
The deer clock visualizes 1 day of movements associated with these influences.
The visual is two concentric circles with the inner circle representing the human's 24-hour clock and the outside representing the influences on deer. Also shown are the actual deer movement events for that day, the wind direction each hour and weather icons.

3. Hot Spots—

this visual is available on the present invention's web app
The objective of this visual is to quickly identify the most active endpoints.
The first filter is to determine the property, the animal type (default ‘all’) and animal name (default ‘all)
The next filter for the visual is the date and the number of days before that date to do the analysis. The default is today and fourteen days of history.
The visual is the property map marking each endpoint with a pillar representing the number of visits. The taller the pillar the more visits. Also, the number of visits is displayed in each pillar.

4. Best Wind—

this visual is available on the present invention's web app
The objective is to find the best wind for the selected hot spots.
The first filter is to determine the property, the animal type (default ‘all’) and animal name (default ‘all)
The next filter for the visual is the date and the number of days before that date to do the analysis. The default is today and fourteen days of history.
The five top endpoints are represented by slices of a pie. In each slice will be eight more slices representing wind direction i.e. N, NE, E, SE, E, SW, W and NW. Each of the eight slices is colored to represent the number of events for each wind direction by endpoint. The actual number of events is displayed in each wind direction slice.
The colors are by the heat colors from blue to red starting in the middle of the circle as blue and the outside of the circle as red.

5. Arrival Time—

this visual is available on the present invention's web app
The objective is to determine when the deer arrive at the selected hot spot that match the wind direction selected in the scroll bar.
The first filter is to determine the property, the animal type (default ‘all’) and animal name (default ‘all)
The second filter is to select either sunrise or sunset.
The third filter for the visual is the date and the number of days before that date to do the analysis. The default is today and fourteen days of history.
The fourth filter is a slider that the user can move to each of the eight wind directions i.e. N, NE, E, SE, E, SW, W and NW.
This visual is a bar graph with the left side as the time before and after sunrise or sunset. The right side is numbered from 1 to 100 representing the probability of the sensor being visited at the allotted wind direction and date. The bottom scale includes the endpoint names. The actual sunrise or sunset time for that date will be represented as a dotted line across the graph horizontally at the level shown on the left side of the graph.
The bars represent the probability of the endpoint being visited with the number of visits displayed inside the pillar.
Above each endpoint matching the time on the left side will be the average arrival time for that endpoint.

6. Arrival Direction—

this visual is available on the present invention's web app
The objective is to visualize the best approach route for the hunter so to avoid contact with the deer on the way in to hunt.
The first filter is to determine the property, the animal type (default ‘all’) and animal name (default ‘all)
The second filter is a slider by hour intervals from a selected begin date to a selected end date.
This visual is a property map showing each endpoint. For each hour, the wind direction and speed are displayed on the map. If there is a 90-degree wind change it is displayed on the map.
As the slider hits each hour there is a heat circle shown next to each endpoint. The heat circle has an arrow showing the arrival direction of the deer in the center of a white pie slice representing one fourth of the circle. Around the other three-fourths of the circle will be three arrows from the other three directions representing the recommended approach direction for the hunter.

7. Weather Factors
The objective of this visual is to study the effect of weather factors, which the present invention labels as influencers. These influencers include severity, moon phase, moon age, wind speed, pressure, humidity, wind direction change, wind speed change, and pressure change.
The first filter is to determine the endpoint, the animal type (default ‘all’) and animal name (default ‘all)
The second filter is to select either sunrise or sunset.
The third filter for the visual is the date and the number of days before that date to do the analysis. The default is today and fourteen days of history.
The fourth filter is to select the influencer.
This visual is a three-dimensional bar graph.
   x-axis: Sunrise or sunset before and after time (2 hours before and 2 hours after)
   y-axis: The frequencies (counts of events) visualized as pillars
   z-axis: The selected influencer each with its own range of values
The base ‘floor’ of the graph represents the counts of influences at the time before or after sunset (this will be in 30 minute increments). The left ‘wall’ has a total of each increment of values for the selected influencer. The ‘back’ wall represents the total of each 30-minute increment of time.

Target Option—

The imager can also be used to automatically score a target shooting contest or simply sight in a gun at distances where the target cannot be easily seen. The present invention's target option can be used at a shooting tournament to instantly show the live scores of all participants. The same imagers, without modification, can be placed in the woods to analyze deer movements.

On the top of the imager is a snap on which to place a laser pointer. When the imager is mounted right in front and below the target the laser pointer will be sighted on the center of the bullseye for an accurate image. To score accurately, the user must use the present invention's paper targets.

If the User has a cellular connection, and If the user is target shooting within range of their gateway already set up on the hunting land they will only need the imager and the invention's mobile app. If the user is not within range of the hunting land they will need to bring the gateway within range of the target. That can either be by the imager or by the shooter. The gateway can be as much as four miles from the target and still receive the image from the imager and the image can be displayed on the present invention's mobile app anywhere there is a mobile app signal.

If the user does not have cellular, then the gateway must be within 100 feet of the present invention's mobile app to be able to connect via Bluetooth. The gateway can be as much as four miles from the target and still receive the image from the imager. The present invention's mobile app will hear the gun shot and immediately take a picture of the target. The image of the target can be seen, within 2.5 seconds, on the present invention's web or mobile app. The user can also take a picture of the target at any time using the present invention's mobile app. The target can be, line of sight, up to four miles away.

The present invention's software will use image processing to accurately measure the shot's distance from the center and score the card. The software will also recommend trends or grouping of shots as to how the user should adjust their sights. The scores and targets will instantly be displayed in front of the participants like the score displays at bowling alleys and stored in the present invention's database for rankings and reports for each participant. The present invention's mobile app can watch the scoring live from anywhere. When the tournament or target practice is done the imager can be placed back in the woods to track animal movement.

Multiple imagers can be permanently placed to operate a shooting range full time. The scores of all participants can be accessible via login to the present inventions web or mobile app to report on long-term progress in shooting accuracy. This present invention can be used for shooting clubs, ranges, tournaments and individually.

Deer Crossings—

A deer crossing sign is placed by the highway department to warn motorists that deer cross the road frequently at that location. This is a great concern for insurance companies to reduce deer and car collisions. The present invention is used to warn motorists when an actual deer is approaching the road. The sensors are placed on the deer trails at the frequent crossing areas. When a deer moves past the sensor the deer crossing sign will flash to warn any oncoming motorists that a deer is on its way to cross the road.

The present invention also predicts the next most likely time of day for deer to cross. This time will be displayed on the deer crossing sign to warn the motorist when the deer are projected to cross. The accuracy of the prediction will increase the longer the present invention is active at that crossing.

The highway department and insurance companies can access reports on the number of crossings, the most frequent times for the crossing all based on various weather conditions and seasons. The reports also include statistics on actual accidents at the crossings.

The present invention includes a double lens imager that takes stereo images to expand the image processing capability. The lenses are placed 5 inches apart vertically to produce two images of the animal from differing angles. The distance to the deer can easily be calculated using the measurements between the backs of the deer in the two images. Using the distance, the Imager can then calculate the body measurements, body weight and antler size. Once the dimensions of the deer are quantified, the deer can be placed in the center of the image with standardized dimensions relating to all deer. All deer will be reproportioned to appear as if they were the same preselected distance from the imager, for example as if they are at five yards from the camera.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An animal movement prediction method, comprising the steps of:
establishing a wireless mesh network of a plurality of remote imaging sensors, the plurality of remote imaging sensors including a first imaging sensor, each of the imaging sensors of the plurality of remote imaging sensors being established in the wireless mesh network by the steps of:
installing the imaging sensor on an object to detect an animal in a detection zone; and
activating the imaging sensor;
obtaining an image by way of the first imaging sensor;
processing the image by removing image information that is not part of an animal in the image thereby creating an animal image and compiling animal detection information of the animal;
receiving the animal detection information from the imaging sensors by way of the mesh network, the animal detection information including at least a time of detection; and
predicting future movements of a plurality of animals dependent upon the animal detection information.

2. The method of claim 1, further comprising the step of capturing a geographic coordinate in a mobile device for at least a portion of the detection zone apart from the imaging sensor, the geographic coordinate not being the coordinate of the imaging sensor.

3. The method of claim 1, further comprising the step of identifying the animal in the animal image.

4. The method of claim 3, further comprising the step of proportioning the animal image to be proportional to an image at a preselected distance from the first imaging sensor.

5. The method of claim 1, wherein the imaging sensors are double lens imaging cameras.

6. The method of claim 1, wherein the animal detection information further includes at least one of a direction of travel of the animal, a type of the animal, a gender of the animal, a quantity of the animal, and an identity of the animal.

7. The method of claim 6, wherein the animal detection information is incorporated into a snapshot of information.

8. The method of claim 7, wherein the snapshot of information further includes categories of information including additional information from the sensor, natural factors of the detection zone, calculated influences and action triggers.

9. The method of claim 7, wherein each time the receiving step receives the animal detection information each snapshot of information is generated and saved to a database.

10. The method of claim 9, wherein the predicting future movements step includes comparing the snapshots of information to predicted future environmental conditions.

11. The method of claim 10, wherein the predicting future movements step further includes using statistical analysis of the snapshots of information and the predicted future environmental conditions to predict a likelihood of an animal being in each detection zone during a predetermined time period.

12. An animal movement prediction method, comprising the steps of:
receiving animal detection information from imaging sensors, each reception defining an animal detection event;
associating a plurality of indicators with each animal detection event thereby creating a snapshot of information;
processing an image taken by a first imaging sensor of the plurality of imaging sensors to removing image information that is not part of an animal in the image thereby creating an animal image and compiling animal detection information of the animal included in the snapshot of information;
saving the snapshot of information; and
predicting future movements of animals dependent upon the snapshots of information and predicted future environmental conditions.

13. The method of claim 12, further comprising the step of identifying the animal in the animal image.

14. The method of claim 13, further comprising the step of proportioning the animal image to be proportional to an image at a preselected distance from the first imaging sensor.

15. The method of claim 12, wherein the imaging sensors are double lens imaging cameras.

16. The method of claim 12, wherein the animal detection information further includes at least one of a direction of travel of the animal, a type of the animal, a gender of the animal, a quantity of the animal, and an identity of the animal.

17. The method of claim 12, further comprising the step of activating an alert associated with a highway sign to alert drivers that a movement of animals onto a roadway is likely.

18. The method of claim 17, wherein the predicting step includes analyzing a direction of travel of animals relative to the roadway before executing the activating step.

19. The method of claim 12, wherein the snapshot of information includes over 50 indicators relating to categories of the animal detection information, additional information from the imaging sensor, natural factors of the detection zone, calculated influences and action triggers.

20. The method of claim 19, wherein the indicators exceed 100.
